(19) United States
(12) Patent Application Publication
(10) Pub. No.: US 2025/0105929 A1
(43) Pub. Date: Mar. 27, 2025

(54) MACHINE LEARNING MODELS FOR PREDICTIVE RESOURCE MANAGEMENT

(71) Applicant: QUALCOMM INCORPORATED, San Diego, CA (US)

(72) Inventors: Qiaoyu Li, Beijing (CN); Arumugam Chendamarai Kannan, San Diego, CA (US); Himanshu Joshi, San Jose, CA (US); Taesang Yoo, San Diego, CA (US); Mahmoud Taherzadeh Boroujeni, San Diego, CA (US); Tao Luo, San Diego, CA (US)

(21) Appl. No.: 18/834,119

(22) PCT Filed: Mar. 8, 2022
(86) PCT No.: PCT/CN2022/079690

§ 371 Date: Jul. 29, 2024

(51) Int. Cl. H04B 17/24; H04B 17/318; H04B 17/373; H04W 24/02

(52) U.S. Cl. CPC H04B 17/24; H04B 17/328; H04B 17/373; H04W 24/02

(57) ABSTRACT

Methods, systems, and devices for wireless communications are described. A network entity may transmit, and a user equipment (UE) may receive, signaling identifying a configuration of a set of multiple machine learning (ML) models for channel characteristic prediction. The channel characteristic prediction may include a channel characteristic prediction for each ML model of the set of multiple ML models based on a respective reference signal resource of the set of multiple reference signal resources. The network entity may obtain an input to the set of multiple ML models based on performing one or more measurements associated with the set of multiple reference signal resources. The network entity may output, and the UE may obtain, the input. The UE may process the input using at least one ML model of the set of multiple ML models to obtain the channel characteristic prediction of the at least one ML model.

### CROSS REFERENCE

The present Application is a 371 national stage filing of International PCT Application No. PCT/CN2022/079690 by Li et al. entitled “MACHINE LEARNING MODELS FOR PREDICTIVE RESOURCE MANAGEMENT,” filed Mar. 8, 2022, which is assigned to the assignee hereof, and which is expressly incorporated by reference in its entirety herein.

### FIELD OF TECHNOLOGY

The following relates to wireless communications, including machine learning (ML) models for predictive resource management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

### SUMMARY

The described techniques relate to improved methods, systems, devices, and apparatuses that support machine learning (ML) models for predictive resource management. For example, the described techniques provide for improving beam prediction performance by employing reference signal specific ML models. For example, a user equipment (UE) and a network entity may both support multiple reference signal resources for respective reference signals (e.g., synchronization signal blocks (SSB) or channel state information reference signals (CSI-RS)). The network entity may transmit signaling identifying a configuration of a set of multiple ML models for channel characteristic prediction. The network entity may obtain an input to the set of multiple ML models by performing one or more measurements on the multiple reference signal resources, and may transmit the input including the one or more measurements. The UE may receive the signaling and the input, and may process the input using one or more ML models of the set of multiple ML models. By processing the input using the one or more ML models, the UE may thus obtain a channel characteristic prediction for a respective reference signal resource of the multiple reference signal resources for each of the one or more ML models. The UE may use one of the channel characteristic predictions to perform a beam refinement procedure for one of the respective reference signal resources (e.g., to determine a reference signal resource measurement cycle). In some examples, the UE may select one of the ML models to use for the beam refinement procedure based on the ML model having a likelihood (e.g., a probability or a binary decision) of being used for the beam refinement procedure being above a threshold. In some cases, the UE may select the ML model based on the channel characteristic prediction for the ML model having a highest value (e.g., having a highest reference signal receive power (RSRP) vector), applying a separate ML model to determine the likelihood of the ML model being used, receiving signaling from a network entity indicating the ML model to select, or any combination thereof.

A method for wireless communication at a UE is described. The method may include receiving signaling identifying a configuration of a set of multiple ML models for channel characteristic prediction, where the channel characteristic prediction for each ML model of the set of multiple ML models is based on a respective reference signal resource of a set of multiple reference signal resources, obtaining an input to one or more ML models of the set of multiple ML models, and processing the input using at least one ML model of the set of multiple ML models to obtain the channel characteristic prediction of the at least one ML model.

An apparatus for wireless communication at a UE is described. The apparatus may include a processor, memory coupled with the processor, and instructions stored in the memory. The instructions may be executable by the processor to cause the apparatus to receive signaling identifying a configuration of a set of multiple ML models for channel characteristic prediction, where the channel characteristic prediction for each ML model of the set of multiple ML models is based on a respective reference signal resource of a set of multiple reference signal resources, obtain an input to one or more ML models of the set of multiple ML models, and process the input using at least one ML model of the set of multiple ML models to obtain the channel characteristic prediction of the at least one ML model.

Another apparatus for wireless communication at a UE is described. The apparatus may include means for receiving signaling identifying a configuration of a set of multiple ML models for channel characteristic prediction, where the channel characteristic prediction for each ML model of the set of multiple ML models is based on a respective reference signal resource of a set of multiple reference signal resources, means for obtaining an input to one or more ML models of the set of multiple ML models, and means for processing the input using at least one ML model of the set of multiple ML models to obtain the channel characteristic prediction of the at least one ML model.

A non-transitory computer-readable medium storing code for wireless communication at a UE is described. The code may include instructions executable by a processor to receive signaling identifying a configuration of a set of multiple ML models for channel characteristic prediction, where the channel characteristic prediction for each ML model of the set of multiple ML models is based on a respective reference signal resource of a set of multiple reference signal resources, obtain an input to one or more ML models of the set of multiple ML models, and process the input using at least one ML model of the set of multiple ML models to obtain the channel characteristic prediction of the at least one ML model.

Some examples of the method, apparatuses, and non-transitory computer-readable medium described herein may further include operations, features, means, or instructions for receiving signaling indicating the at least one ML model and selecting the at least one ML model based on the signaling.

Some examples of the method, apparatuses, and non-transitory computer-readable medium described herein may further include operations, features, means, or instructions for selecting the at least one ML model based on the channel characteristic prediction of the at least one ML model having a likelihood of being used to determine a reference signal resource measurement cycle above a threshold.

Some examples of the method, apparatuses, and non-transitory computer-readable medium described herein may further include operations, features, means, or instructions for determining the likelihood of being used to determine the reference signal resource measurement cycle for each ML model of the set of multiple ML models based on applying a separate ML model.

In some examples of the method, apparatuses, and non-transitory computer-readable medium described herein, the threshold may be a probability value or a binary output.

Some examples of the method, apparatuses, and non-transitory computer-readable medium described herein may further include operations, features, means, or instructions for selecting the at least one ML model based on the channel characteristic prediction of the at least one ML model having a greatest RSRP vector of the one or more ML models.

Some examples of the method, apparatuses, and non-transitory computer-readable medium described herein may further include operations, features, means, or instructions for receiving an indication of the one or more ML models from a network entity.

Some examples of the method, apparatuses, and non-transitory computer-readable medium described herein may further include operations, features, means, or instructions for receiving first signaling indicating one or more common layers corresponding to a common set of weights for the set of multiple ML models, one or more individual layers corresponding to an individual set of weights for the set of multiple ML models, or any combination thereof.

Some examples of the method, apparatuses, and non-transitory computer-readable medium described herein may further include operations, features, means, or instructions for updating the one or more individual layers corresponding to the individual set of weights for the set of multiple ML models based on training the set of multiple ML models according to federated learning.

Some examples of the method, apparatuses, and non-transitory computer-readable medium described herein may further include operations, features, means, or instructions for receiving second signaling indicating for the UE to train the set of multiple ML models, where the updating may be based on the second signaling.

Some examples of the method, apparatuses, and non-transitory computer-readable medium described herein may further include operations, features, means, or instructions for transmitting a report including one or more target metrics associated with the channel characteristic prediction and receiving the input to the one or more ML models based on the report.

In some examples of the method, apparatuses, and non-transitory computer-readable medium described herein, the input for each ML model of the one or more ML models includes a time series of RSRP vectors associated with the respective reference signal resource of the each ML model, a bitmap indicating one or more indices of one or more respective strongest reference signal resources based on a RSRP vector of the time series of RSRP vectors, or any combination thereof.

In some examples of the method, apparatuses, and non-transitory computer-readable medium described herein, the channel characteristic prediction includes a probability or a binary output indicating that a first index of the respective reference signal resource with a strongest RSRP may be different from a second index of an additional reference signal resource associated with a strongest RSRP for the input for a duration including a time between when the respective reference signal resource and the additional reference signal resource may be measured.

In some examples of the method, apparatuses, and non-transitory computer-readable medium described herein, the channel characteristic prediction includes an indication of one or more likelihoods that a reference signal resource measurement cycle will change for one or more respective threshold number of times.

In some examples of the method, apparatuses, and non-transitory computer-readable medium described herein, the at least one ML model predicts one or more future channel characteristics based on one or more current channel characteristic measurements, one or more previous channel characteristic measurements, or any combination thereof associated with the respective reference signal resource.

In some examples of the method, apparatuses, and non-transitory computer-readable medium described herein, the at least one ML model predicts one or more channel characteristics of the respective reference signal resource, an angle of departure for downlink precoding associated with the respective reference signal resource, a linear combination of one or more measurements associated with the respective reference signal resource, or any combination thereof.

In some examples of the method, apparatuses, and non-transitory computer-readable medium described herein, the at least one ML model predicts one or more channel characteristics for a first frequency range based on measuring one or more channel characteristics for a second frequency range.

In some examples of the method, apparatuses, and non-transitory computer-readable medium described herein, the channel characteristic prediction includes a RSRP prediction, a signal-to-interference-plus-noise ratio (SINR) prediction, a rank indicator (RI) prediction, a precoding matrix indicator (PMI) prediction, a layer indicator (LI) prediction, a channel quality indicator (CQI) prediction, or a combination thereof.

In some examples of the method, apparatuses, and non-transitory computer-readable medium described herein, the set of multiple reference signal resources include an SSB resource, a CSI-RS resource, or any combination thereof.

A method for wireless communication at a network entity is described. The method may include transmitting signaling identifying a configuration of a set of multiple ML models for channel characteristic prediction, where the channel characteristic prediction for each ML model of the set of multiple ML models is based on a reference signal resource of a set of multiple reference signal resources, obtaining an input to the set of multiple ML models based on performing one or more measurements associated with the set of multiple reference signal resources, and outputting the input including the one or more measurements.

An apparatus for wireless communication at a network entity is described. The apparatus may include a processor, memory coupled with the processor, and instructions stored in the memory. The instructions may be executable by the processor to cause the apparatus to transmit signaling identifying a configuration of a set of multiple ML models for channel characteristic prediction, where the channel characteristic prediction for each ML model of the set of multiple ML models is based on a reference signal resource of a set of multiple reference signal resources, obtain an input to the set of multiple ML models based on performing one or more measurements associated with the set of multiple reference signal resources, and output the input including the one or more measurements.

Another apparatus for wireless communication at a network entity is described. The apparatus may include means for transmitting signaling identifying a configuration of a set of multiple ML models for channel characteristic prediction, where the channel characteristic prediction for each ML model of the set of multiple ML models is based on a reference signal resource of a set of multiple reference signal resources, means for obtaining an input to the set of multiple ML models based on performing one or more measurements associated with the set of multiple reference signal resources, and means for outputting the input including the one or more measurements.

A non-transitory computer-readable medium storing code for wireless communication at a network entity is described. The code may include instructions executable by a processor to transmit signaling identifying a configuration of a set of multiple ML models for channel characteristic prediction, where the channel characteristic prediction for each ML model of the set of multiple ML models is based on a reference signal resource of a set of multiple reference signal resources, obtain an input to the set of multiple ML models based on performing one or more measurements associated with the set of multiple reference signal resources, and output the input including the one or more measurements.

Some examples of the method, apparatuses, and non-transitory computer-readable medium described herein may further include operations, features, means, or instructions for outputting an indication of one or more ML models of the set of multiple ML models for processing the input.

Some examples of the method, apparatuses, and non-transitory computer-readable medium described herein may further include operations, features, means, or instructions for outputting first signaling indicating one or more common layers corresponding to a common set of weights for the set of multiple ML models, one or more individual layers corresponding to an individual set of weights for the set of multiple ML models, or any combination thereof.

Some examples of the method, apparatuses, and non-transitory computer-readable medium described herein may further include operations, features, means, or instructions for outputting second signaling indicating for a UE to train the set of multiple ML models.

Some examples of the method, apparatuses, and non-transitory computer-readable medium described herein may further include operations, features, means, or instructions for obtaining a report including one or more target metrics associated with the channel characteristic prediction and outputting the input based on the report.

In some examples of the method, apparatuses, and non-transitory computer-readable medium described herein, the input includes a time series of RSRP vectors associated with a respective reference signal resource of each ML model, a bitmap indicating an index of a strongest reference signal resource based on a RSRP vector of the time series of RSRP vectors, or any combination thereof.

In some examples of the method, apparatuses, and non-transitory computer-readable medium described herein, the channel characteristic prediction includes an indication of a likelihood that a first RSRP of a respective reference signal resource may be different from a second RSRP associated with the input.

In some examples of the method, apparatuses, and non-transitory computer-readable medium described herein, the channel characteristic prediction includes an indication of one or more likelihoods that a reference signal resource measurement cycle will change for one or more respective threshold number of times.

In some examples of the method, apparatuses, and non-transitory computer-readable medium described herein, the channel characteristic prediction includes a RSRP prediction, a SINR prediction, a RI prediction, a PMI prediction, a LI prediction, a CQI prediction, or a combination thereof.

In some examples of the method, apparatuses, and non-transitory computer-readable medium described herein, the set of multiple reference signal resources include an SSB resource, a CSI-RS resource, or any combination thereof.

### BRIEF DESCRIPTION OF THE DRAWINGS

FIGS. 1 and 2 illustrate examples of wireless communications systems that support machine learning (ML) models for predictive resource management in accordance with one or more aspects of the present disclosure.

FIG. 3 illustrates an example of an ML model diagram that supports ML models for predictive resource management in accordance with one or more aspects of the present disclosure.

FIG. 4 illustrates an example of a process flow that supports ML models for predictive resource management in accordance with one or more aspects of the present disclosure.

FIGS. 5 and 6 show block diagrams of devices that support ML models for predictive resource management in accordance with one or more aspects of the present disclosure.

FIG. 7 shows a block diagram of a communications manager that supports ML models for predictive resource management in accordance with one or more aspects of the present disclosure.

FIG. 8 shows a diagram of a system including a device that supports ML models for predictive resource management in accordance with one or more aspects of the present disclosure.

FIGS. 9 and 10 show block diagrams of devices that support ML models for predictive resource management in accordance with one or more aspects of the present disclosure.

FIG. 11 shows a block diagram of a communications manager that supports ML models for predictive resource management in accordance with one or more aspects of the present disclosure.

FIG. 12 shows a diagram of a system including a device that supports ML models for predictive resource management in accordance with one or more aspects of the present disclosure.

FIGS. 13 through 18 show flowcharts illustrating methods that support ML models for predictive resource management in accordance with one or more aspects of the present disclosure.

### DETAILED DESCRIPTION

Wireless communication systems may support beam sweeping procedures for selecting a beam for communications between a user equipment (UE) and a network entity, which may be a base station or one of multiple components arranged in a disaggregated architecture. A UE may select one or more beams to receive or transmit communications on by measuring and comparing channel characteristics using the reference signal resource for each beam, such as a synchronization signal block (SSB), a channel state information reference signal (CSI-RS), or the like. However, measuring and comparing channel characteristics for each beam for a relatively large number of beams may cause increased latency, overhead, or excessive power consumption at the UE. To mitigate these issues, a system may employ the use predictive models such as long short-term memory (LSTM) based beam change prediction, where machine learning (ML) may be used to predict whether a top beam index will change based on different inputs (e.g., historically measured channel characteristics). For instance, a UE may report values for current beams (e.g., a reference signal receive power (RSRP)), and a network entity may then use an ML-model to predict whether or not the beam will change by using past values (e.g., past RSRP values). However, use of a single model across multiple sets of reference signal resources (e.g., across multiple SSBs or multiple CSI-RSs)) may reduce efficiency of LSTM based beam predictions due to performance inequalities between reference signals, thereby increasing overhead as well as power consumed at a UE.

Techniques described herein may support improved beam prediction performance by employing reference signal specific ML models. For example, a UE and network entity may both support multiple reference signal resources for respective reference signals (e.g., SSBs or CSI-RSs). A UE may receive signaling that identifies a configuration of an ML model for each reference signal resource for predicting channel characteristics. The UE may input measurements taken by a network entity of reference signals into one or more ML models. The output of the ML models may be a channel characteristic prediction for a reference signal resource of each ML model. The UE may use the channel characteristic prediction to perform a beam refinement procedure for the reference signal resource. In some examples, the UE may select the ML model to use for the beam refinement procedure based on a likelihood of the ML model being used for the beam refinement procedure, a likelihood of the reference signal being a strongest reference signal, running a separate ML model to select the ML model, explicit signaling from a network entity, or any combination thereof.

Aspects of the disclosure are initially described in the context of wireless communications systems. Aspects of the disclosure are further illustrated by and described with reference to apparatus wireless communications systems, ML model diagrams, and process flows. Aspects of the disclosure are further illustrated by and described with reference to apparatus diagrams, system diagrams, and flowcharts that relate to ML models for predictive resource management.

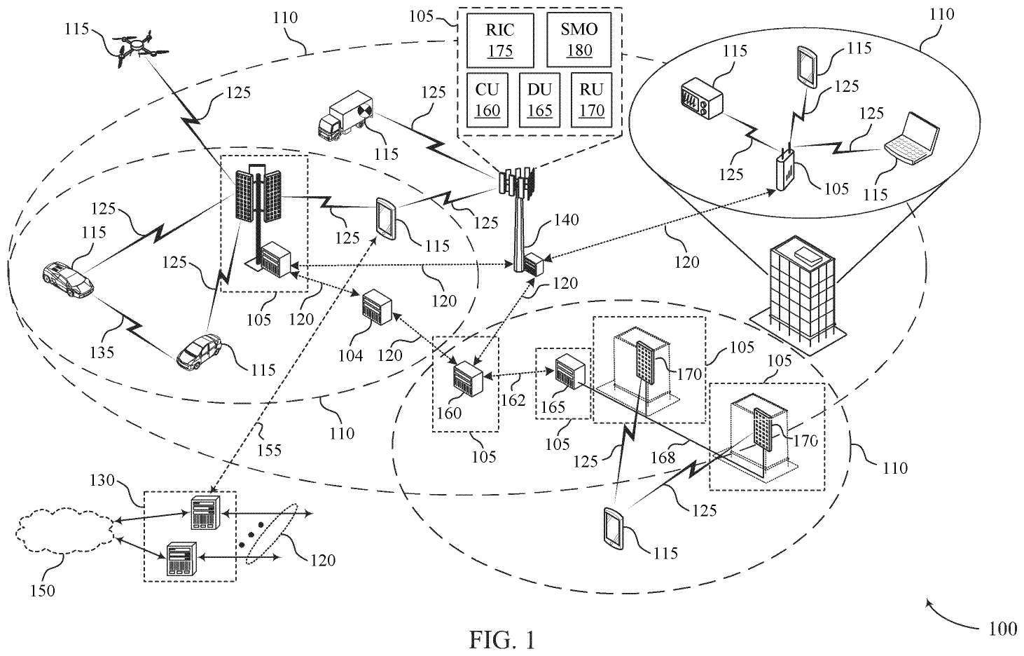

FIG. 1 illustrates an example of a wireless communications system 100 that supports ML models for predictive resource management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support ML models for predictive resource management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink (DL) component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

As described herein, the wireless communications system 100 may support techniques for improving beam prediction performance by employing reference signal specific ML models. For example, a network entity 105 may configure a UE 115 with one or more ML models for each reference signal resource for channel characteristic prediction. In some cases, the network entity 105 or the UE 115 may train the multiple ML models before or after the configuration of the UE 115 (e.g., using supervised learning). In some examples, the multiple ML models may be trained according to federated learning, such as by training different layers at individual wireless devices (e.g., one or more individualized layers at UEs 115). In some cases, the multiple ML models may include common and non-common components (e.g., layers) or values (e.g., weights), and in some cases, the non-common components may be updated according to federated learning. In some examples, the network entity 105 may perform reference signal resource measurements on the reference signal resources to generate input data for the UE 115. The UE 115 may process the input data using one or more ML models to obtain channel characteristic predictions. For example, the UE 115 may input the input data into one or more ML models concurrently. In some cases, the input data may include a vector of metric values (e.g., RSRP values) for beams associated with each supported reference signal resource. The one or more ML models may output predicted channel characteristics, predicted states for whether a preferred beam may change or not, or both.

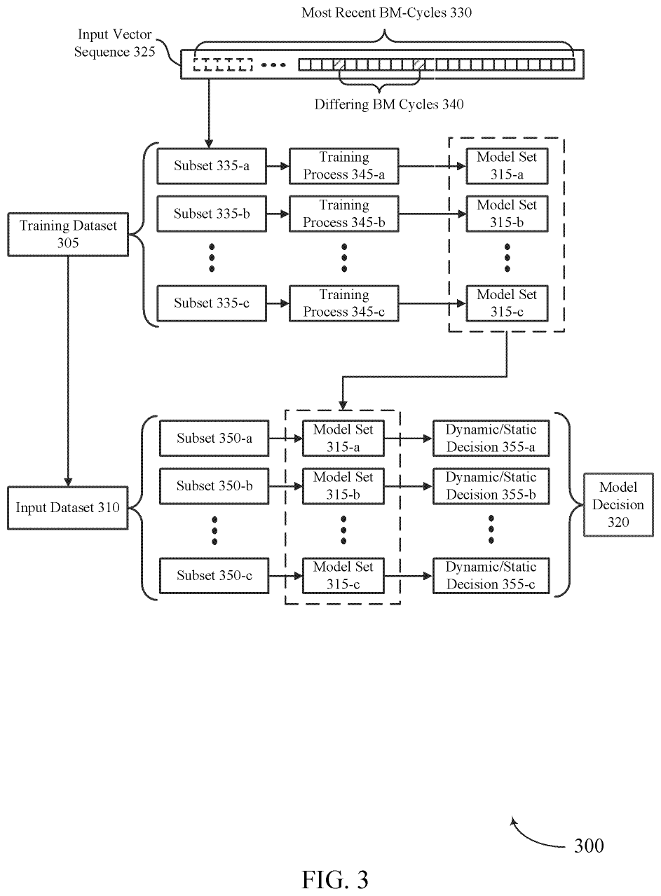

In some examples, a network entity 105 may send configuration signaling for model parameters and criteria to a UE 115. The UE 115 may determine a model or model output to use for the predictions. For example, a UE 115 may select a ML model or ML model output of multiple ML models to use for a beam refinement procedure, which is described in further detail with respect to FIG. 3. In some cases, a UE 115 may select an ML model to use based on a probability or binary decision (e.g., likelihood) of the ML model being used for beam refinement procedures on one or more reference signal resources (e.g., on one or more SSBs, CSI-RSs, or both). In some examples, a UE 115 may select the ML model to use based on a likelihood of a reference signal being a strongest reference signal, running a separate ML model to select the ML model, explicit signaling from a network entity 105, or any combination thereof. In some examples, a UE 115 may report one or more target parameters, or metrics, for achieving a highest false alarm probability (FAP) given a target misdetection probability (MDP) value, or vice versa.

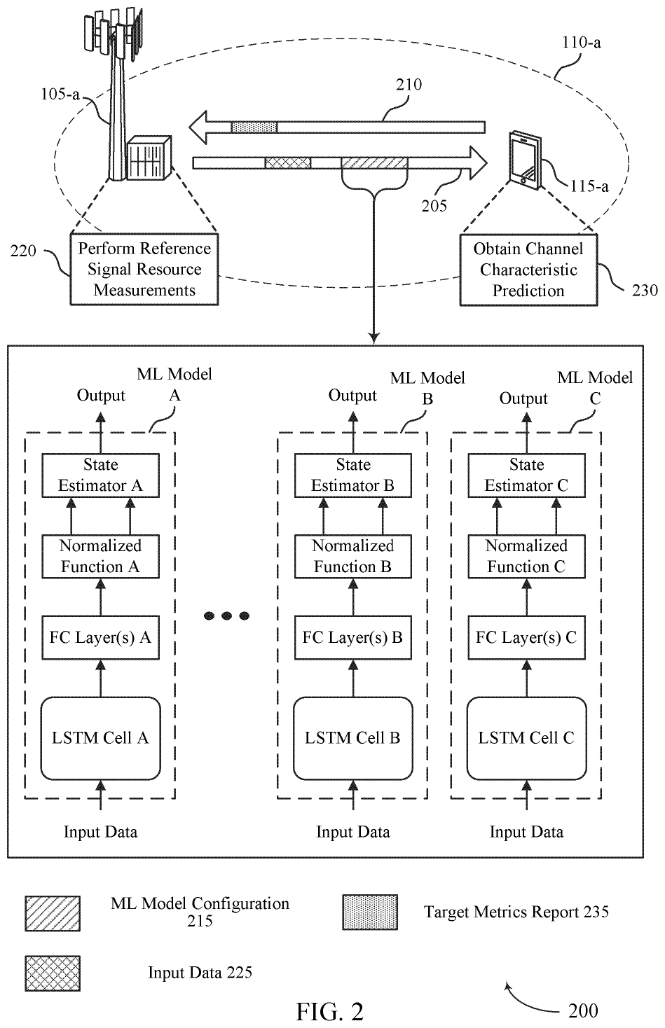

FIG. 2 illustrates an example of a wireless communications system 200 that supports ML models for predictive resource management in accordance with one or more aspects of the present disclosure. In some examples, the wireless communications system 200 may implement, or be implemented by, aspects of the wireless communications system 100. The wireless communications system 200 may include a network entity 105-a with a coverage area 110-a and a UE 115-a, which may be examples of the network entities 105 with coverage areas 110 and the UEs 115 described with reference to FIG. 1. In some examples, the network entity 105-a may communicate control information, data, or both with the UE 115-a using a downlink communication link 205. Similarly, the UE 115-a may communicate control information, data, or both with the network entity 105-a using an uplink communication link 210. For example, the network entity 105-a may transmit an ML model configuration 215 to the UE 115-a via a downlink communication link 205 for obtaining channel characteristic predictions using multiple ML models.

In some examples, to establish communications between the network entity 105-a and the UE 115-a, the network entity 105-a and the UE 115-a may perform one or more beam management (BM) procedures. For example, the network entity 105-a and the UE 115-a may perform beam sweeping procedures as described with reference to FIG. 1 during an initial access, beam measurement and determination procedures during a connected mode, beam reporting procedures during the connected mode (e.g., L1 report for beam refinement), and beam recovery procedures for a beam failure recovery (BFR) or a radio link failure (RLF). In an initial access procedure, the network entity 105-a may transmit in multiple directions (e.g., beams) to synchronize for communications with the UE 115-a. For example, the network entity 105-a may transmit a reference signal, such as an SSB, a CSI-RS, or both in a set of directions using supported beams (e.g., may sweep through multiple SSB resources). In some examples, the network entity 105-a and UE 115-a may use wider beams for the initial access procedure, such as L1 beams. The UE 115-a may receive one or more reference signals on the respective beams, and may select or report one or more preferred beams based on a signal metric. For example, the UE 115-a may send a report to the network entity 105-a indicating an SSB with a greatest RSRP value for a random access channel (RACH) procedure. The described procedure may also be performed by the network entity 105-a for selection of a transmission beam of the UE 115-a and for fine tuning of a receive beam at the network entity 105-a.

In some examples, there may be one or more different types of BM procedures, such as a first procedure type for downlink beams (P1), a second procedure type for downlink beams (P2), and a third procedure type for downlink beams (P3), a first procedure type for uplink beams (U1), a second procedure type for uplink beams (U2), and a third procedure type for uplink beams (U3).

In some examples, the network entity 105-a and the UE 115-a may use hierarchical beam refinement to select narrower beam pairs for communications (e.g., using P1, P2, P3, or any combination thereof). For example, for P1, the network entity 105-a may sweep through multiple wider beams, and the UE 115-a may select a beam and report it to the network entity 105-a. For P2, the network entity 105-a may transmit in multiple relatively narrow directions (e.g., may sweep through multiple narrower beams in a narrower range), where the narrow directions may be based on the direction of the selected wide beam pair. The UE 115-a may receive a reference signal on the wide beams, and may report one of the narrow beams to use for transmissions, thus refining the transmission beam. For P3, the network entity 105-a may transmit the selected beam repeatedly (e.g., may fix the beam), and the UE 115-a may refine a receive beam (e.g., select a narrower receive beam) based on the transmitted beam. In some examples, P1, P2, and P3 processes may be used for downlink BM. In some examples, the network entity 105-a and the UE 115-a may employ uplink BM procedures for selecting a wide uplink beam pair, refining an uplink receive beam at the network entity 105-a, and refining an uplink transmit beam at the UE 115-a, which may be examples of U1, U2, and U3 processes, respectively. In some cases, the UE 115-a may report beams using a physical layer (e.g., using L1 reporting). In some examples, the UE 115-a and the network entity 105-a may be in a connected mode with successful connection through selected beam pairs.

In some examples, the network entity 105-a and the UE 115-a may experience beam failure. For example, the UE 115-a may lose a connection with the network entity 105-a through the selected beam pairs. In some examples, the UE 115-a may perform BFR to select new suitable beam pairs through additional beam sweeping procedures. In some examples, the UE 115-a may be unable to find another suitable beam, and may experience RLF, resulting in a loss of connection with the network entity 105-a.

In some examples, beam sweeping procedures may exhibit inefficiencies in communications. For example, the network entity 105-a and the UE 115-a may perform excessive beam sweeping before selecting a suitable beam. Excessive beam sweeping may cause excessive latency, overhead, and power usage at the UE 115-a (e.g., by altering phase shifting components for transmitting in new directions).

In some examples, the network entity 105-a and the UE 115-a may use ML based beam change prediction to mitigate drawbacks and improve beam sweeping procedures. For example, the network entity 105-a may implement an ML model (e.g., ML model A) to predict channel characteristics for communications. In some examples, the ML model may be an example of a deep learning ML model, where a deep learning ML model may include multiple layers of operations between input and output. For example, the ML model may represent a convolution neural network (CNN) model, a recurrent neural network (RNN) model, a generative adversarial network (GAN) model, or any other deep learning or other neural network model. In some examples, the ML model may represent a subset of RNN models, such as an LSTM model, where an LSTM model may involve learning and memorizing long-term dependencies over time to make predictions based on time series data. For example, the ML model may include an LSTM cell (e.g., an LSTM cell A) with a time-series input, and may transfer outputs from the LSTM cell into additional instances of the cell over time for selectively updating ML model values to make predictions. In some examples, the ML model may predict whether a preferred reference signal beam will remain preferred compared to a last received beam based on historical measurements. For example, the ML model may predict whether or not an SSB beam with a current highest RSRP will have the highest RSRP at a next measurement occasion.

In some examples, the network entity 105-a may train an ML model using a learning approach. For example, the network entity 105-a may train an ML model using supervised, semi-supervised, or unsupervised learning. Supervised learning may involve ML model training based on labeled training data, which may include example input-output pairs, whereas unsupervised learning may involve ML model training based on unlabeled training data, consisting of data without example input-output pairs. Semi-supervised learning may involve a small amount of labeled training data and a large amount of unlabeled training data. In some cases, the ML model (e.g., the ML model A) may use supervised learning for prediction as described herein.

In some examples, the UE 115-a may transmit a message including one or more reference signal indices and values of one or more preferred beams to the network entity 105-a. For example, the UE 115-a may report SSB indices and RSRP values associated with SSBs with the top two highest RSRP values. In some cases, the UE 115-a may transmit the one or more reference signal indices and the one or more values in a report to the network entity 105-a (e.g., in a channel state information (CSI) report). In some examples, the one or more reference signal indices may include one or more indices associated with selected beams currently used for transmissions between the network entity 105-a and the UE 115-a (e.g., a selected SSB or CSI-RS beam pair). By way of another example, the one or more selected beams may include one or more beams currently not in use for transmissions between the network entity 105-a and the UE 115-a, and may represent preferred beams identified by the UE 115-a in the report. For example, the one or more non-selected beams may represent beams not in use that have a higher RSRP than currently selected beams.

In some examples, the network entity 105-a may input a set of input data into a single ML model, such as one of ML model A through ML model C, including information for a set of multiple reference signal beams supported at the network entity 105-a. For example, the network entity may support 8 beams (e.g., 8 SSBs) and may input a vector including values for each beam of the 8 beams. For example, the network entity 105-a may input a vector in time series xₜ (1×8)=[η₁(t), . . . , η₈(t)] for a time t including standardized RSRP values η(t) of 8 supported SSBs. In some examples, the vector may include the two beams corresponding to the two reference signal indices in the message transmitted by the UE 115-a. Additionally, or alternatively, the values of the other 6 beams in the vector may be set to a defined low value or weight (e.g., the non-reported SSBs may be set to −110 decibel milliwatts (dBm) and may not be accounted for when calculating mean or variance of the input data of the vector). In some examples, the network entity 105-a may input one or more other vectors containing different information into the ML model.

In some examples, the set of input data may be input first into an LSTM cell (e.g., the LSTM cell A). In some examples, the network entity 105-a may input data from a previous iteration of the LSTM cell (e.g., may input a cell state cₜ₋₁ at a time t−1 and a hidden state hₜ₋₁ at the time t−1). The LSTM cell may process the set of input data and the data from the previous instance using multiple calculations, such as by performing differing operations on the data, and combining different variables using addition, multiplication, tanh, σ, or other operations. In some examples, the LSTM cell may output data for a next iteration. For example, the LSTM cell may output a cell state cₜ at the time t and a hidden state hₜ at the time t to an instance of the LSTM cell at a time t+1.

In some examples, the LSTM cell may output data for processing by the rest of the components of the LSTM cell. For example, the LSTM cell may output data into one or more fully connected (FC) layers (e.g., FC layer(s) A). In some examples, the output data may include a vector (e.g., an output vector hₜ=1×32). In some examples, the one or more FC layers may represent one or more mappings of the output of the LSTM cell to determined output sizes. In some examples, the one or more FC layers apply defined weights to the output of the LSTM cell. For example, the one or more FC layers may process the output data from the LSTM cell A according to the weights, and may output a result (an output vector yₜ (1×2)) into a normalized function (e.g., a sigmoid or softmax function). In some examples, the normalized function may involve compressing the output result within a range of 0 to 1. In some cases, the normalized function may output two probabilities (e.g., between 0 and 1). For example, the two probabilities may represent a probability that the preferred beam may change (e.g., Pr_{dynamic},), or a probability that the preferred beam may not change (e.g., Pr_{stable}). In some examples, the normalized function may output the two probabilities to a state estimator (e.g., a state estimator A).

In some examples, the state estimator may determine a final predicted state from the two probabilities. For example, the state estimator may process the two probabilities and may output a final state corresponding to a final prediction that the preferred beam may change or will not change until a next measurement occasion. In some cases, the state estimator may output a dynamic state, indicating a prediction that the preferred beam will change. In some examples, the network entity 105-a may determine to perform measurements at the next opportunity based on the dynamic prediction. For example, the network entity 105-a may indicate to the UE 115-a to measure the actual RSRP values of the 8 supported SSBs to measure any real changes, and may follow a shorter measurement periodicity. In some examples, the state estimator may output a static (e.g., stable) state, indicating a prediction that the preferred beam will not change. In some examples, the network entity 105-a may determine to refrain from performing measurements until a later time based on the static prediction. For example, the network entity 105-a may follow a longer measurement periodicity as a result of the static prediction. In some examples, the network entity 105-a may calculate an MDP and an FAP for the estimated state by comparing the estimated state with labeled values.

In some examples, the ML based beam prediction operations described herein may improve efficiencies by enabling the UE 115-a to measure less frequently when the predicted probability indicates a static prediction. However, using a single ML model for LSTM based beam prediction may cause inaccuracies and deficiencies in calculations. Thus, improved designs may be desired.

As described herein, the wireless communications system 200 may support techniques for improving beam prediction performance by employing reference signal specific ML models. For example, the network entity 105-a and the UE 115-a may both support multiple reference signal resources for respective reference signals (e.g., SSBs or CSI-RSs). In some examples, the network entity 105-a and the UE 115-a may establish the downlink communication link 205 and an uplink communication link 210. In some examples, the network entity 105-a may configure the UE 115-a with multiple ML models corresponding to the multiple reference signal resources for channel characteristic prediction by transmitting the ML model configuration 215 to the UE 115-a. For example, the network entity 105-a may transmit the ML model configuration 215 in control signaling on the downlink communication link 205, where the ML model configuration 215 may include weights for each ML model.

In some examples, the multiple ML models in the ML model configuration 215 may include one or more weights for the ML model A, the ML model B, and the ML model C. In some examples, the ML model configuration 215 may indicate weights for any number of ML models. Each ML model of the ML models A-C may include a respective LSTM cell, one or more FC layers, a normalized function, and a state estimator. For example, the ML model A may include the LSTM cell A, the one or more FC layers A, the normalized function A, and the state estimator A. The ML model B may include LSTM cell B, one or more FC layers B, normalized function B, and state estimator B. The ML model C may include LSTM cell C, one or more FC layers C, normalized function C, and state estimator C. The UE 115-a, the network entity 105-a, or both may input data into respective LSTM cells to obtain an output. For example, the ML model A may receive input data (e.g., into the LSTM cell A) and may output respective output data (e.g., from the state estimator A).

In some examples, each ML model of the ML models A-C may be associated with a reference signal resource index within a set of reference signal resource indices corresponding to the multiple reference signal resources. For example, each ML model may be associated with a different SSB resource index in a set of SSB resource indices corresponding to a target SSB or a different CSI-RS resource index in a set of CSI-RS resource indices corresponding to a target CSI-RS.

In some examples, at 220, the network entity 105-a may perform reference signal resource measurements on the multiple reference signal resources. For example, the network entity 105-a may receive reference signals in the multiple reference signal resources, and may measure one or more of a RSRP, receive signal strength indicator (RSSI), reference signal receive quality (RSRQ), or the like. In some examples, the network entity 105-a may generate the input data 225 from performing the measurements at 220. In some cases, the network entity 105-a may transmit the input data 225 to the UE 115-a on the downlink communication link 205. For example, the network entity 105-a may transmit the input data 225 before or after transmitting the ML model configuration 215.

In some examples, at 230, the UE 115-a may process the input data 225 generated at 220 using one or more ML models of the ML models A-C to obtain channel characteristic predictions. For example, the network entity 105-a may configure the UE 115-a with the ML models A-C according to the ML model configuration 215, and the UE 115-a may deploy the one or more ML models of the ML models A-C. In some cases, at 230, the UE 115-a may input measurements from the input data 225 into the one or more ML models. For example, the UE 115-a may input a vector including measured RSRP values of supported beams. In some examples, the UE 115-a may input the measurements into the ML model A by first inputting the measurements into the LSTM cell A. The LSTM cell A may process the measurements and may output results to the one or more FC layers A, which may process the results and output data to the normalized function A. The normalized function A may normalize the data and may output one or more probabilities to the state estimator A, which may output a prediction based on the one or more probabilities. In some examples, the UE 115-a may also input the measurements into the ML model B and the ML model C, which may similarly generate predictions. In some examples, the predictions may include predicted channel characteristics, a predicted state (e.g., whether or not a preferred SSB will change), or both.

In some examples, the ML models A-C may be used for one or more time domain beam predictions, one or more spatial domain beam predictions, one or more frequency domain beam predictions, or a combination thereof. In some cases, the one or more time, spatial, or frequency domain beam predictions may include one or more channel characteristic predictions for different beams (e.g., may include predictions for L1 RSRPs, L1 signal-to-interference-plus-noise ratios (SINR), rank indicators (RI), PMIs, layer indicators (L1), channel quality indicators (CQI), or any combination thereof). In some examples, the one or more time domain predictions may include predicting future channel characteristics based on a history of channel measurements associated with the multiple reference signal resources. For example, the one or more time domain predictions may be based on a history of measurements taken at processes similar to the process at 220, or based on measurements taken at the UE 115-a, on one or more SSB or CSI-RS resources.

In some examples, the one or more spatial domain predictions may include predicting channel characteristics of non-measured reference signal resources (e.g., SSB or CSI-RS resources) based on the measured multiple reference signal resources. In some cases, the one or more spatial domain predictions may include predicting an angle of departure (AoD) for downlink precoding based on the measured multiple reference signal resources, or may include predicting a linear combination of the measured multiple reference signal resources as preferred downlink precoding.

In some examples, the one or more frequency domain predictions may include predicting channel characteristics of a first serving cell defined in a first frequency range based on channel measurements associated with one or more reference signal resources of a second serving cell defined in a second frequency range. For example, the one or more frequency domain predictions may include predicting channel characteristics for cross-frequency range prediction where cross-frequency range is configured in different serving cells. In some examples, the UE 115-a may use each model of the ML models A-C for either time domain predictions, spatial domain predictions, frequency domain predictions, or a combination thereof, as described herein. For example, each of the ML models A-C may be associated with a different SSB index or beam associated with a different domain.

In some examples, the ML models A-C may represent differently configured models. For example, the ML models A-C may differ by number of ML values (e.g., may include different numbers of neurons, coefficients, or weights). In some examples, the network entity 105-a or the UE 115-a may train the ML models A-C based on different data to weight the models differently. In some examples, network entity 105-a or the UE 115-a may configure the ML models A-C with same input and output definitions.

In some examples, the UE 115-a may report target metrics to the network entity 105-a. For example, the UE 115-a may transmit a target metrics report 235 on the uplink communication link 210. In some examples, the target metrics report 235 may define a target FAP or a target MDP as described herein. In some examples, the UE 115-a may transmit the target metrics report 235 before or after receiving the ML model configuration 215 and the input data 225. In some cases, the UE 115-a may use the target MDP, FAP, or both for predicting that a preferred beam will change. For example, the UE 115-a may use a target metric to predict whether an SSB index or CSI-RS resource indicator (CRI) with a highest RSRP will be different than an SSB index or CRI with a highest RSRP in a vector recently input into one or more ML models (e.g., in the input data 225 input into the LSTM cell A). In some examples, the UE 115-a may make the prediction for a time duration starting at least from a time when the recently input vector is measured until a next measurement occasion when a next expected input vector may be measured. In some examples, the UE 115-a may report a target MDP, FAP, or both, based on a target throughput or power efficiency configuration.

In some examples, the network entity 105-a may configure ML models for the UE 115-a based on the target metrics report 235. For example, the network entity 105-a may receive the target metrics report 235 after sending the ML model configuration 215, and may update and transmit a second ML model configuration on the downlink communication link 205 to update the ML models used by the UE 115-a. In some examples, the models may be based on an MDP and FAP tradeoff, which may reflect the target throughput or power efficiency at the UE 115-a. For example, target metrics report 235 may include a relatively low MDP or a relatively high FAP, and the network entity 105-a may accordingly configure the UE 115-a with one or more models weighted to mistakenly predict a higher number of dynamic states. In some examples, the higher number of dynamic state predictions may result in a higher throughput in communications. By way of another example, the target metrics report 235 may include a relatively high MDP or a relatively low FAP, and the network entity 105-a may configure the UE 115-a with one or more models weighted to miss a higher number of dynamic states. In some examples, the higher number of missed dynamic states may result in less frequent communications and greater power savings at the UE 115-a. In some examples, the network entity 105-a may receive the target metrics report 235 before sending the ML model configuration 215, and may initially configure the UE 115-a with an ML model configuration 215 based on the target metrics report 235. In some examples, the ML model configuration 215 may include values for updating ML models configured at the UE 115-a (e.g., weights). In some examples, the network entity 105-a may choose a model from a set of trained models based on the target metrics report 235 for configuring the UE 115-a. For example, the network entity 105-a may send the trained models to the UE 115-a in the ML model configuration 215.

In some examples, using reference signal specific LSTM (e.g., with smaller model sizes for respective SSBs) for predictive BM may provide improved performance compared to using a single model across supported reference signal resources (e.g., using a greater model size for supported SSBs). In some examples, the network entity 105-a may include configuration and signaling design to identify specific model parameters and criteria to the UE 115-a for determining a final model or final model output to use in predictions. For example, the UE 115-a may select a ML model or ML model output of the multiple ML models in the ML model configuration 215 to use for a beam refinement procedure using techniques described further in reference to FIG. 3. For example, the UE 115-a may select an ML model to use based on a likelihood of the ML model being used for beam refinement procedures on one or more reference signal resources of multiple reference signal resources (e.g., on one or more SSBs). In some examples, the UE 115-a may select the ML model to use based on a likelihood of a reference signal being a strongest reference signal, running a separate ML model to select the ML model, explicit signaling from the network entity 105-a, or any combination thereof. In some examples, the configuration and signaling design may include parameters for achieving a highest FAP given a target MDP value, or vice versa. In some cases, configuration and signaling design at the network entity 105-a may reduce overhead in operations.

FIG. 3 illustrates an example of an ML model diagram 300 that supports ML models for predictive resource management in accordance with one or more aspects of the present disclosure. In some examples, the ML model diagram 300 may implement, or be implemented by, aspects of the wireless communications system 100 or the wireless communications system 200. For example, the ML model diagram 300 may represent training the ML models A-C at either the network entity 105-a or the UE 115-a, and implementing the models A-C to process data at the UE 115-a as described with respect to FIG. 2. The ML model diagram 300 may include a training dataset 305 and an input dataset 310. In some examples, a device may train the ML model sets 315 using the training dataset 305. In some examples, the device may process the input dataset 310 using the ML model sets 315 to make one or more channel characteristic or state predictions. In some cases, the device may represent any type of network entity, a UE, or any other type of device. In some cases, different devices may perform the training and the processing. For example, a network entity may train the ML model sets 315 using the training dataset 305, and a UE may process the input dataset 310 using the ML model sets 315. In some examples, at 320, the device may decide on which ML model set or which ML model set output of the ML model sets 315 to use for a beam refinement procedure.

In some examples, the ML model set 315-a through the ML model set 315-c may include common and non-common components. For example, each ML model set 315 may share a number of hidden layers, where a hidden layer may represent a layer between input and output layers in an ML model that may include weights or an activation function (an FC layer, a normalized function, etc.). Each ML model set 315 may share a common FC layer. In some examples, the ML model sets 315 may share copies of a common FC layer that connects the output of an LSTM cell to a softmax function as described with reference to FIG. 2. Additionally, or alternatively, each ML model set 315 may share a number of coefficient values (e.g., weights or biases) within different hidden layers. For example, each ML model set 315 may include multiple hidden layers in respective LSTMs, and may include identical weights or biases for a number of the hidden layers in the respective LSTMs (e.g., a number of last LSTM layers). In some examples, multiple hidden layers in an LSTM may represent multiple concatenated LSTM cells.

In some cases, a network entity may transmit a ML model configuration to one or more UEs, as described with reference to FIG. 2. The ML model configuration may include updated values for common components or non-common components. In some examples, such signaling may be carried in different downlink messages such as in an RRC message, a MAC control element (MAC-CE) message, a downlink control indicator (DCI), higher layer configurations, or a combination thereof. In some examples, a MAC-CE or a DCI may include messages that indicate different control information to a UE. In some examples, higher layer configurations may include application layer configurations, where the application layer may include a layer at which users interact with the device.

In some examples, the ML model sets 315 may include input and output definitions. For example, the ML model sets 315 may include time domain input definitions, and may include as input one or more time-series of vectors, which may represent one or more input vector sequences 325. In some examples, each input vector sequence 325 may include one or more vectors including one or more measurements corresponding to supported beams. For example, each vector may include a number of RSRQ values or a number of RSRP values for respective beams as described with reference to FIG. 2. In some examples, each vector may represent an RSRP vector, and may include RSRP values of respective SSBs within a set of SSBs or with respective CSI-RSs within a set of CSI-RSs. In some cases, an input vector sequence 325 may be filled or partially filled. For example, an input vector sequence 325 may include a total number of possible elements (e.g., 50 possible elements), and may include a set of most recent BM cycles 330, which may take up N elements of the total number of possible elements (e.g., N=30 elements). The set of most recent BM cycles 330 may represent vectors of beam measurements taken during N most recent BM cycles, or at the most recent N times when the supported beams were measured. For example, a UE may take measurements during 30 time instances and may report those measurements to a network entity in an input vector sequence 325. Additionally, or alternatively, the ML model sets 315 may include bitmaps indicating an index of a beam (e.g., an SSB or CSI-RS resource) with a strongest connection or a highest metric, such as a highest RSRP value. For example, each RSRP vector within the time-series of RSRP vectors may include a respective bitmap that may indicate the indices of a number of K SSBs or CSI-RS resources with highest RSRP values.

In some examples, a network entity may indicate the bitmaps to a device (e.g., a UE). For example, a network entity may receive a subset of measurements of supported beams indicating beams with highest RSRP values from a UE. In some examples, the subset of measurements may be reported through a physical uplink control channel (PUCCH), where a PUCCH may be used for transmitting uplink control information (CQI, acknowledgment messages, scheduling requests, etc.). In some examples, the network entity may not be able to retrieve measurements of other supported beams by a UE, and may set the beams without values to a defined lower value, such as −110 dBm as described with reference to FIG. 2. In some examples, the network entity may indicate the beams with the highest RSRP values to the UE via the bitmaps. The UE may use the bitmaps to improve training of the ML model sets 315 for prediction based on the bitmaps indicating which values in input data are set to defined values instead of measured values. In some examples, the number of K SSBs or CSI-RS resources with highest RSRP values may represent the subset of measurements including beams with highest RSRP values reported by the UE. In some examples, the UE may determine the bitmap at the UE by performing measurements on each supported beam. In some examples, the network entity may indicate the bitmap to the UE as described herein, which may enable the UE to perform fewer measurements, or to measure each supported beam less frequently. In some examples, the bitmaps may improve prediction performance at the ML model sets 315.

In some examples, the ML model sets 315 may include output definitions. For example, the ML model sets 315 may include, as output, a probability or hard-decision that an SSB with a highest RSRP may change. For example, the probability or hard-decision may define a prediction of whether an SSB or CSI-RS resource (e.g., associated with an SSB index or CSI-RS resource indicator (CRI)) with a highest RSRP may be different than an SSB or CSI-RS resource with a highest RSRP in a vector recently input into one or more of the ML model sets 315. In some examples, the UE 115-a may make the prediction for a time duration starting at least from a time when a recent input vector is measured until a next measurement occasion when a next expected input vector may be measured.

Additionally, or alternatively, the ML model sets 315 may include, as output, a probability or hard-decision (e.g., binary decision) that processes at a device may benefit from increasing or decreasing a BM cycle with a number of X cycles compared to a current BM cycle. For example, the ML model sets 315 may output multiple probabilities, where each probability may be associated with an increased or decreased number of X cycles. In some examples, the ML model sets 315 may include definitions for inputs or outputs according to the time domain, spatial domain, the frequency domain, or other domains. In some examples, a network entity or a device may configure the ML model sets 315 at the device with the input and output definitions described herein. In some examples, the device or the network entity may configure the ML model sets 315 with same input and output definitions.

In some examples, a device (e.g., a network entity or a UE) may divide the training dataset 305 into one or more smaller subsets for training the ML model sets 315. For example, the device may divide the training dataset 305 into subset 335-a through subset 335-c based on a sorting criteria. In some examples, the training dataset 305 may include one or more input vector sequences 325 (e.g., RSRP vector sequences) as described herein, and a sorting criteria may represent any differing characteristic of the one or more input vector sequences 325 that may separate the one or more input vector sequences 325 according to related beams. For example, the device may divide the training dataset 305 based on most frequently dominant beams. In some cases, each set of most recent BM cycles 330 may include a most frequently dominant beam, a least frequently dominant beam, or the like. In some examples, a most frequently dominant beam may represent a beam associated with a beam index with a highest RSRP value for a majority of the set of most recent BM cycles 330. For example, out of N vectors in a set of most recent BM cycles 330 for an input vector sequence 325, a first beam (e.g., associated with a first SSB) may have a highest RSRP value for a majority of the N vectors.

In some examples, the set of most recent BM cycles 330 may include 28 vectors (e.g., measurement occasions) where the first beam may have a highest RSRP out of 30 total vectors. Each set of most recent BM cycles 330 may thus include a set of differing BM cycles 340. In some examples, the set of differing BM cycles 340 may represent a minority of vectors where the first beam did not have a highest RSRP value. In some examples, the device may include the input vector sequence 325 with the first beam as the most frequently dominant beam in the subset 335-a. In some examples, the subset 335-a may be associated with the first beam (e.g., with a first SSB). In some examples, the device may further divide the training dataset 305 by sorting additional input vector sequences 325 into corresponding subset 335-b, subset 335-c, and other subsets according to a most frequently dominant beam in each input vector sequence 325, where each subset may be associated with each corresponding different beam.

In some examples, the device may train the ML model sets 315 by performing one or more training processes 345 on corresponding subsets 335. For example, the device may input the assigned input vector sequences 325 for each of the subset 335-a through the subset 335-c into a respective ML model set 315-a through ML model set 315-c at a training process 345-a through training process 345-c. In some examples, the device may train the ML model sets 315 using the subsets 335 to bias the ML model sets 315 towards each associated beam. For example, during training, the device may implement a cross entropy loss function, which may weight some values lower based on an expected value. In some examples, such weighting may involve weighting values for a beam for an ML model set 315 higher than values for other beams to bias the ML model set 315. In some examples, the training processes 345 may involve supervised, semi-supervised, or unsupervised learning as described with reference to FIG. 2.

In some examples, the device may train the ML models sets 315 using federated learning. In some examples, federated learning may reduce sharing of device specific data, such that UEs may train one or more layers of a ML model without uploading device data to another device (e.g., a network entity or cloud server device). For example, a device (e.g., a UE) may train the ML model sets 315 using device data by obtaining the training dataset 305 from the device data. In some examples, the device may transmit the trained ML model sets 315 to another device (e.g., a network entity or cloud server device) without sending the device data or one or more personalized layers. In some examples, the device may update non-common components of the ML model sets 315 when training the ML model sets 315 with federated learning. For example, a network entity may configure the device with common layers (e.g., a common FC layer), and may indicate to the device to update the non-common components (e.g., personalized layers) according to federated learning to further refine the ML model sets 315. In some examples, the device may update or configure the ML model sets 315 for federated learning according to a configuration message such as the ML model configuration described with respect to FIG. 2.

In some examples, the device may receive explicit indication from a network entity indicating which ML models set 315 of the ML model set 315-a through the ML model set 315-c to train. For example, a network entity may receive a report from the device indicating a beam as having a highest RSRP in a majority of a set of most recent BM cycles 330. The network entity may transmit a message indicating to the device to use the ML model set 315 for the beam for measured data during a number of next BM cycles 330. For example, the network entity may indicate to the device to update the ML model set 315 for the beam and to refrain from updating the other ML model sets 315 during the number of next BM cycles 330. In some examples, the network entity may indicate to update the non-common components of the ML model set 315 for the beam as described with reference to training the ML model sets 315 and to refrain from updating the non-common components of the other ML model sets 315.

In some examples, a device (e.g., a UE) may process input data using the ML model sets 315. For example, the input dataset 310 may include one or more input vector sequences 325 including vectors of beam specific metric values similar to the input vector sequences 325 described with reference to the training dataset 305. In some examples, the device may divide the input dataset 310 into the subset 350-a through the subset 350-c. In some examples, the subsets 350 may be instances or copies of the input dataset 310. For example, the device may copy the input dataset 310 for inputting measurements from the input dataset 310 into each of the ML model set 315-a through the ML model set 315-c. In some examples, the device may process the subsets 350 using corresponding ML model sets 315 in parallel by running the models at the same time. In some cases, processing the subsets 350 using the ML model sets 315 may represent processing the subsets 350 according to different models weighted towards different beams (e.g., different SSBs, CSI-RSs, or both) as described herein.

In some examples, the ML model sets 315 may output one or more predicted channel characteristics, one or more probabilities or hard-decisions (e.g., binary decisions) on whether a beam with a highest metric will change or not, or a combination thereof. In some examples, the device may make a dynamic or static state decision 355-a through dynamic or static decision 355-c based on respective ML model set 315 outputs. For example, an ML model set 315 (e.g., ML model set 315-a for a beam) may output a probability that the last measured beam with the highest RSRP may have a highest RSRP in a next measurement occasion. The device may thus decide for a less frequent, static measurement periodicity based on the probability output from the ML model set 315.

In some examples, a device (e.g., a UE) may decide at 320 on which ML model set, or which ML model set output, to use for a beam refinement procedure on a supported reference signal resource (e.g., a beam, such as an SSB or CSI-RS resource). For example, the device may use the outputs from the ML model set 315-a through the ML model set 315-c to decide on an ML model set 315 to use for making final predictions for channel characteristics or a final state. In some examples, the selected ML model set 315 or ML model set 315 output may be chosen for refining a BM cycle. In some cases, the selected ML model set 315 may be chosen based on a criteria, where the criteria for selecting the ML model set 315 may be indicated to the device through a configuration, which may be a dynamic indication from a network entity. For example, a network entity may send a separate indication in a DCI message, a MAC-CE message, an RRC message, or any other downlink signaling to the device before or after configuration of the ML model sets 315 indicating a criteria for selecting the final ML model set 315.

In some examples, a device may determine a final ML model set 315 to use based on additional outputs from the ML mode sets 315. For example, each ML model set 315 may output a probability or hard-decision that the output associated with the ML model set 315 and a beam corresponding to the ML model set 315 (e.g., an SSB or a CRI) may have a highest metric value. In some examples, the probability or hard-decision may indicate whether or not the corresponding beam has a highest predicted RSRP value. In some examples, when the output comprises a probability, the device may decide on a final ML model set 315 based on which ML model set 315 outputs the highest probability. In some examples, when the output comprises a hard-decision, which may also be referred to as a binary decision, the device may decide on a final ML model set 315 based on one of the ML model sets 315 having a positive hard-decision value. For example, the device may choose the ML model set 315-a, where the ML model set 315-a may output a +1, and the ML model set 315-b and the ML model set 315-c may output a−1. In some examples, multiple ML model sets 315 may output a positive value. For example, two of the ML model sets 315 may output a +1.

In some examples, when multiple ML model sets 315 output positive values, the device may decide to choose the multiple ML model sets 315 with the positive output values, and may use another criteria to determine a final ML model set 315 for a beam refinement procedure. For example, the device may randomly choose one of the positive output ML model sets, or may choose a different criteria for deciding as described herein. In some examples, choosing the ML model set 315 based on the probably or hard-decision output may base the decision on predictions of whether or not RSRP values for a supported beam may change.

In some examples, the device may determine a final ML model set 315 to use based on an associated beam having a highest value over a number of most recent measurement occasions. In some examples, the device may determine that an SSB or CSI-RS resource associated with the ML model set 315-a may have a highest RSRP value compared to other supported SSBs or CSI-RS resources for a majority of N most recent BM cycles 330. For example, the ML model set 315-a may have a highest RSRP in 28 of 30 most recent BM cycles 330, where N=30. By way of another example, the device may choose an ML model set 315 with a highest RSRP for a highest number of cycles. For example, for N=10, the ML model set 315-a may have a highest RSRP for 4 cycles, where the ML model set 315-b may have a highest RSRP for 3 cycles, and the ML model set 315-c may have a highest RSRP for 3 cycles. As the ML model set 315-a has a highest RSRP for a greatest number of BM cycles 330, the device may choose the ML model set 315-a. In some examples, more than one of the associated beams may have a highest RSRP value for an equal highest number of cycles. For example, the ML model set 315-a and the ML model set 315-b may both have a highest RSRP for 5 occasions out of 10 total occasions. In some examples, one or more ML model sets 315 may include a same highest RSRP value in one or more BM cycles 330. In some examples, when multiple ML model sets 315 have equal highest numbers of cycles, or a different equality in RSRP values in a number of BM cycles 330, the device may use another criteria to determine a final ML model set 315 for a beam refinement procedure. For example, the device may randomly choose one of the multiple ML model sets 315 with the same highest number of occasions, or may choose a different criteria for deciding as described herein.

In some examples, the device may determine a final ML model set 315 to use based for a beam refinement procedure based on an indication from a network entity. For example, a UE may receive, from a network entity, a message indicating one of the ML model set 315-a through the ML model set 315-c to use for a beam refinement procedure via a downlink message (e.g., in a DCI, a MAC-CE message, an RRC message, or the like). In some examples, the network entity may base the indication on data indicating a potential coverage for the UE. For example, location data at the network entity may indicate that the UE, in a number of next BM cycles 330, may likely be at a location associated with a direction of a supported beam, but not associated with other supported beams. In some examples, the network entity may determine that the UE may likely have a highest RSRP using the beam based on the location information, and may indicate to the UE to use the ML model set 315-a, where the ML model set 315-a may be associated with the beam. In some examples, the network entity may dynamically alter indications to UEs that are close to each other. For example, the network entity may dynamically alter the indications in signaling for multiple UEs using group common DCI messages (GC-DCI).

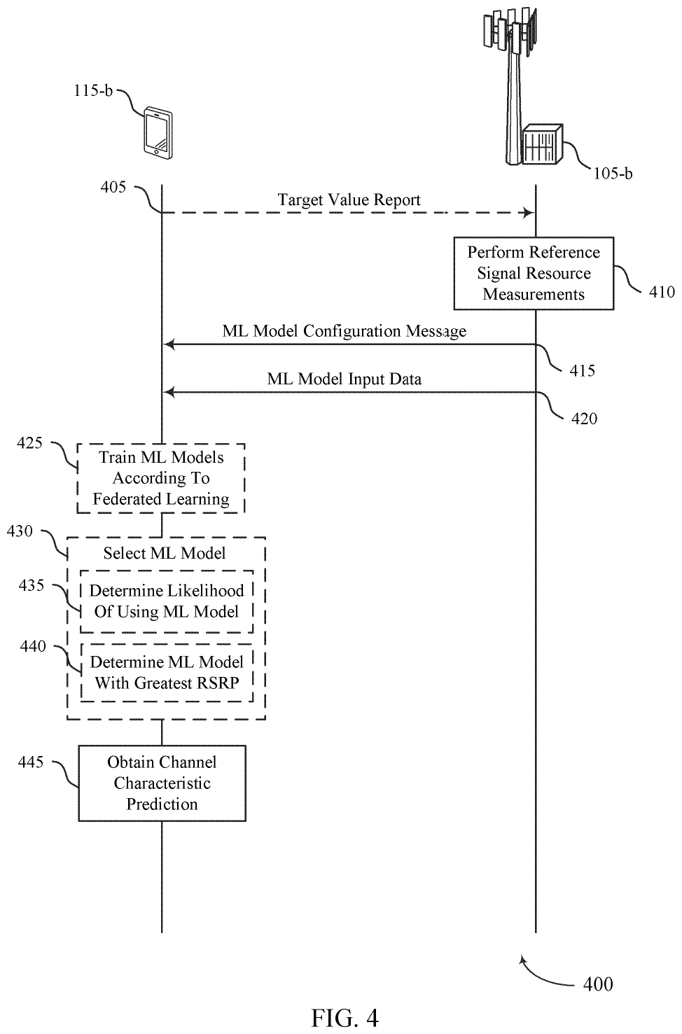

FIG. 4 illustrates an example of a process flow 400 that supports ML models for predictive resource management in accordance with one or more aspects of the present disclosure. In some examples, the process flow 400 may implement aspects of wireless communications system 100, wireless communications system 200, and ML model diagram 300. The process flow 400 may illustrate an example of a UE 115-b obtaining channel characteristic predictions based on being configured with multiple ML models. Network entity 105-b and UE 115-b may be examples of a network entity 105 and a UE 115 as described with reference to FIGS. 1 and 2. Alternative examples of the following may be implemented, where some processes are performed in a different order than described or are not performed. In some cases, processes may include additional features not mentioned below, or further processes may be added.

At 405, a UE 115-b may transmit a report to a network entity 105-b. The report may include one or more target metrics for a channel characteristic prediction (e.g., MDP or FAP metrics).

At 410, the network entity 105-b may perform reference signal resource measurements on one or more reference signals from UEs, such as UE 115-b. The reference signal may include SSB signals, CSI-RSs, or the like. In some examples, the network entity 105-b may perform the reference signal resource measurements to obtain an input to one or more ML models.

At 415, the network entity 105-b may transmit signaling (e.g., control signaling) identifying a ML model configuration for ML models. There may be a ML model for each reference signal resource, where the reference signals for each resource may be SSB signals, CSI-RSs, or the like. The control signaling may include a DCI message, RRC signaling or messages, a MAC-CE, or the like. The UE 115-a, the network entity 105-b, or both may implement the ML models for channel characteristic prediction, such as RSRP, SINR, RI, PMI, LI, CQI, or a combination thereof.

In some cases, the network entity 105-b may transmit signaling indicating one or more common layers with a common set of weights for the ML models, one or more individual layers with an individual set of weights for the ML models, or any combination thereof, to the UE 115-b. The ML model configuration message may include the signaling. In some examples, the network entity 105-b may transmit signaling indicating for the UE 115-b to train the ML models in the ML model configuration message or in a separate message.

At 420, the network entity 105-b may transmit ML model input data, which may include the measurements performed at 410. The network entity 105-b may include the ML model input data in same control signaling as the ML model configuration message at 415 or in different control signaling. In some cases, the UE 115-b may receive the input to the one or more ML models based on the target value report at 405. For example, the network entity 105-b may transmit ML model input data to align with the target metrics included in the target value report (e.g., to hit a target MDP or FAP value).

In some cases, the input for each ML model may include a time series of RSRP vectors for respective reference signal resources of each ML model, a bitmap indicating one or more indices of one or more respective strongest reference signal resources based on a RSRP vector, or any combination thereof.

In some examples, the control signaling at 415, the control signaling at 420, or both may include an indication of at least one ML model for the UE 115-b to use for channel characteristic prediction.

At 425, the UE 115-b may update the one or more individual layers with the individual set of weights according to a federated learning technique. For example, the UE 115-b may receive signaling indicating for the UE 115-b to train the ML models according to federated learning. The UE 115-b may train one or more layers of the ML model using data specific to the UE 115-b, which may create one or more personalized layers of the ML model.

At 430, the UE 115-b may select at least one ML model to use for channel characteristic prediction. For example, at 435, the UE 115-b may determine the likelihood (e.g., probability or binary output or decision) of the channel characteristic prediction of the ML model being used to determine a reference signal resource measurement cycle above a threshold. The UE 115-b may select the ML model based on the likelihood being above the threshold. The UE 115-b may determine the likelihood of a ML model being used to determine the reference signal resource measurement cycle for each ML model based on applying a separate ML model. In some other examples, at 440, the UE 115-b may determine a ML model with a highest RSRP. The UE 115-b may select the ML model with the highest RSRP.

At 445, the UE 115-b may process the input using at least one ML model (e.g., the selected model). The UE 115-b may obtain the channel characteristic prediction of the ML model.

In some examples, the channel characteristic prediction may include a probability or a binary output indicating that a first index of the respective reference signal resource with a strongest RSRP is different from a second index of an additional reference signal resource associated with a strongest RSRP for the input for a duration including a time between when the respective reference signal resource and the additional reference signal resource are measured. Additionally, or alternatively, the channel characteristic prediction may include an indication of one or more likelihoods that a reference signal resource measurement cycle may change for one or more respective threshold number of times.

In some cases, the selected ML model may predict one or more future channel characteristics based on one or more current channel characteristic measurements, one or more previous channel characteristic measurements, or any combination thereof for the respective reference signal resource. In some other cases, the selected ML model may predict one or more channel characteristics of the respective reference signal resource, an AoD for downlink precoding for the respective reference signal resource, a linear combination of one or more measurements for the respective reference signal resource, or any combination thereof. The selected ML model may predict one or more channel characteristics for a frequency range based on measured channel characteristics for a different frequency range.

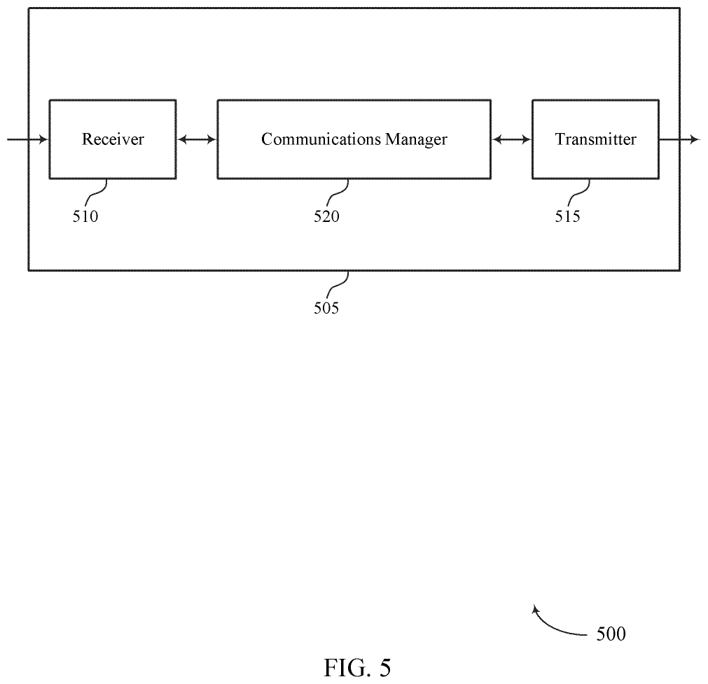

FIG. 5 shows a block diagram 500 of a device 505 that supports ML models for predictive resource management in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to ML models for predictive resource management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to ML models for predictive resource management). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of ML models for predictive resource management as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving signaling identifying a configuration of a set of multiple ML models for channel characteristic prediction, where the channel characteristic prediction for each ML model of the set of multiple ML models is based on a respective reference signal resource of a set of multiple reference signal resources. The communications manager 520 may be configured as or otherwise support a means for obtaining an input to one or more ML models of the set of multiple ML models. The communications manager 520 may be configured as or otherwise support a means for processing the input using at least one ML model of the set of multiple ML models to obtain the channel characteristic prediction of the at least one ML model.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for a network entity to configure multiple ML models at a UE for channel characteristic prediction at the UE, which may provide for reduced power consumption and more efficient utilization of communication resources.

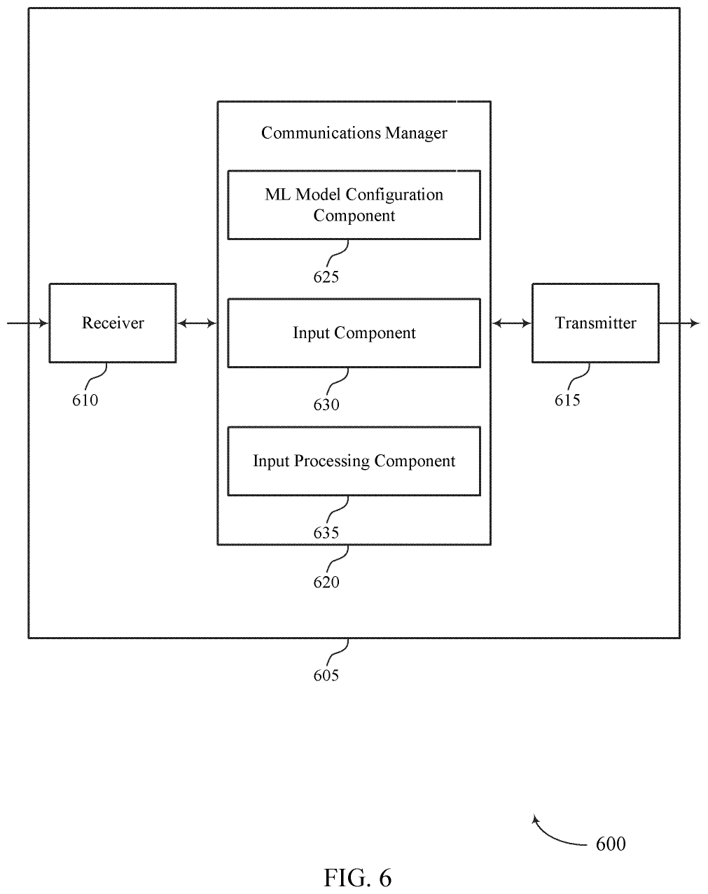

FIG. 6 shows a block diagram 600 of a device 605 that supports ML models for predictive resource management in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to ML models for predictive resource management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to ML models for predictive resource management). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of ML models for predictive resource management as described herein. For example, the communications manager 620 may include an ML model configuration component 625, an input component 630, an input processing component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The ML model configuration component 625 may be configured as or otherwise support a means for receiving signaling identifying a configuration of a set of multiple ML models for channel characteristic prediction, where the channel characteristic prediction for each ML model of the set of multiple ML models is based on a respective reference signal resource of a set of multiple reference signal resources. The input component 630 may be configured as or otherwise support a means for obtaining an input to one or more ML models of the set of multiple ML models. The input processing component 635 may be configured as or otherwise support a means for processing the input using at least one ML model of the set of multiple ML models to obtain the channel characteristic prediction of the at least one ML model.

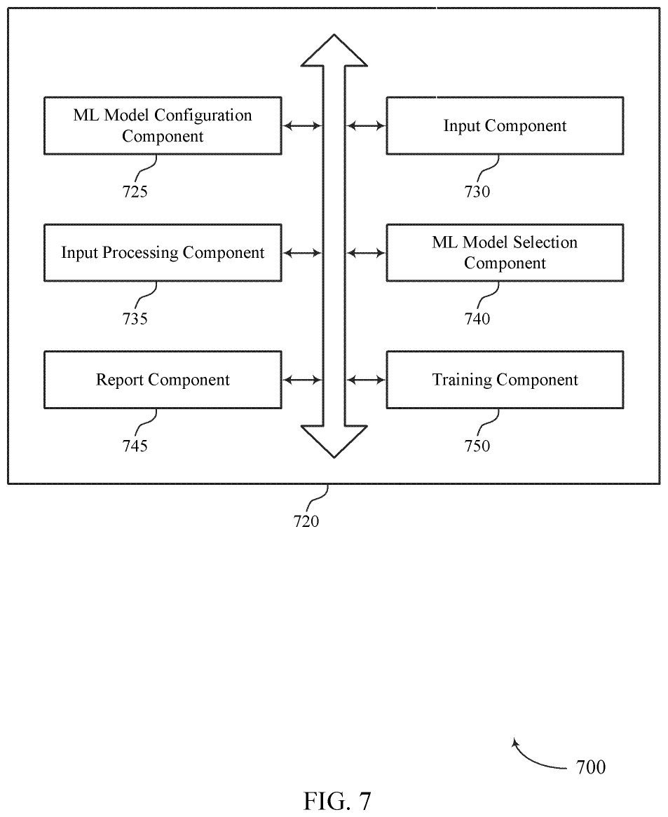

FIG. 7 shows a block diagram 700 of a communications manager 720 that supports ML models for predictive resource management in accordance with one or more aspects of the present disclosure. The communications manager 720 may be an example of aspects of a communications manager 520, a communications manager 620, or both, as described herein. The communications manager 720, or various components thereof, may be an example of means for performing various aspects of ML models for predictive resource management as described herein. For example, the communications manager 720 may include an ML model configuration component 725, an input component 730, an input processing component 735, an ML model selection component 740, a report component 745, a training component 750, or any combination thereof. Each of these components may communicate, directly or indirectly, with one another (e.g., via one or more buses).

The communications manager 720 may support wireless communication at a UE in accordance with examples as disclosed herein. The ML model configuration component 725 may be configured as or otherwise support a means for receiving signaling identifying a configuration of a set of multiple ML models for channel characteristic prediction, where the channel characteristic prediction for each ML model of the set of multiple ML models is based on a respective reference signal resource of a set of multiple reference signal resources. The input component 730 may be configured as or otherwise support a means for obtaining an input to one or more ML models of the set of multiple ML models. The input processing component 735 may be configured as or otherwise support a means for processing the input using at least one ML model of the set of multiple ML models to obtain the channel characteristic prediction of the at least one ML model.

In some examples, the ML model selection component 740 may be configured as or otherwise support a means for receiving signaling indicating the at least one ML model. In some examples, the ML model selection component 740 may be configured as or otherwise support a means for selecting the at least one ML model based on the signaling.

In some examples, the ML model selection component 740 may be configured as or otherwise support a means for selecting the at least one ML model based on the channel characteristic prediction of the at least one ML model having a likelihood of being used to determine a reference signal resource measurement cycle above a threshold.

In some examples, the ML model selection component 740 may be configured as or otherwise support a means for determining the likelihood of being used to determine the reference signal resource measurement cycle for each ML model of the set of multiple ML models based on applying a separate ML model.

In some examples, the threshold is a probability value or a binary output.

In some examples, the ML model selection component 740 may be configured as or otherwise support a means for selecting the at least one ML model based on the channel characteristic prediction of the at least one ML model having a greatest RSRP vector of the one or more ML models.

In some examples, the ML model configuration component 725 may be configured as or otherwise support a means for receiving an indication of the one or more ML models from a network entity.

In some examples, the ML model configuration component 725 may be configured as or otherwise support a means for receiving first signaling indicating one or more common layers corresponding to a common set of weights for the set of multiple ML models, one or more individual layers corresponding to an individual set of weights for the set of multiple ML models, or any combination thereof.

In some examples, the training component 750 may be configured as or otherwise support a means for updating the one or more individual layers corresponding to the individual set of weights for the set of multiple ML models based on training the set of multiple ML models according to federated learning.

In some examples, the training component 750 may be configured as or otherwise support a means for receiving second signaling indicating for the UE to train the set of multiple ML models, where the updating is based on the second signaling.

In some examples, the report component 745 may be configured as or otherwise support a means for transmitting a report including one or more target metrics associated with the channel characteristic prediction. In some examples, the input component 730 may be configured as or otherwise support a means for receiving the input to the one or more ML models based on the report.

In some examples, the input for each ML model of the one or more ML models includes a time series of RSRP vectors associated with the respective reference signal resource of the each ML model, a bitmap indicating one or more indices of one or more respective strongest reference signal resources based on an RSRP vector of the time series of RSRP vectors, or any combination thereof.

In some examples, the channel characteristic prediction includes a probability or a binary output indicating that a first index of the respective reference signal resource with a strongest RSRP is different from a second index of an additional reference signal resource associated with a strongest RSRP for the input for a duration including a time between when the respective reference signal resource and the additional reference signal resource are measured.

In some examples, the channel characteristic prediction includes an indication of one or more likelihoods that a reference signal resource measurement cycle will change for one or more respective threshold number of times.

In some examples, the at least one ML model predicts one or more future channel characteristics based on one or more current channel characteristic measurements, one or more previous channel characteristic measurements, or any combination thereof associated with the respective reference signal resource.

In some examples, the at least one ML model predicts one or more channel characteristics of the respective reference signal resource, an AoD for downlink precoding associated with the respective reference signal resource, a linear combination of one or more measurements associated with the respective reference signal resource, or any combination thereof.

In some examples, the at least one ML model predicts one or more channel characteristics for a first frequency range based on measuring one or more channel characteristics for a second frequency range.

In some examples, the channel characteristic prediction includes an RSRP prediction, an SINR prediction, an RI prediction, a PMI prediction, an LI prediction, a CQI prediction, or a combination thereof.

In some examples, the set of multiple reference signal resources include an SSB resource, a CSI-RS resource, or any combination thereof.

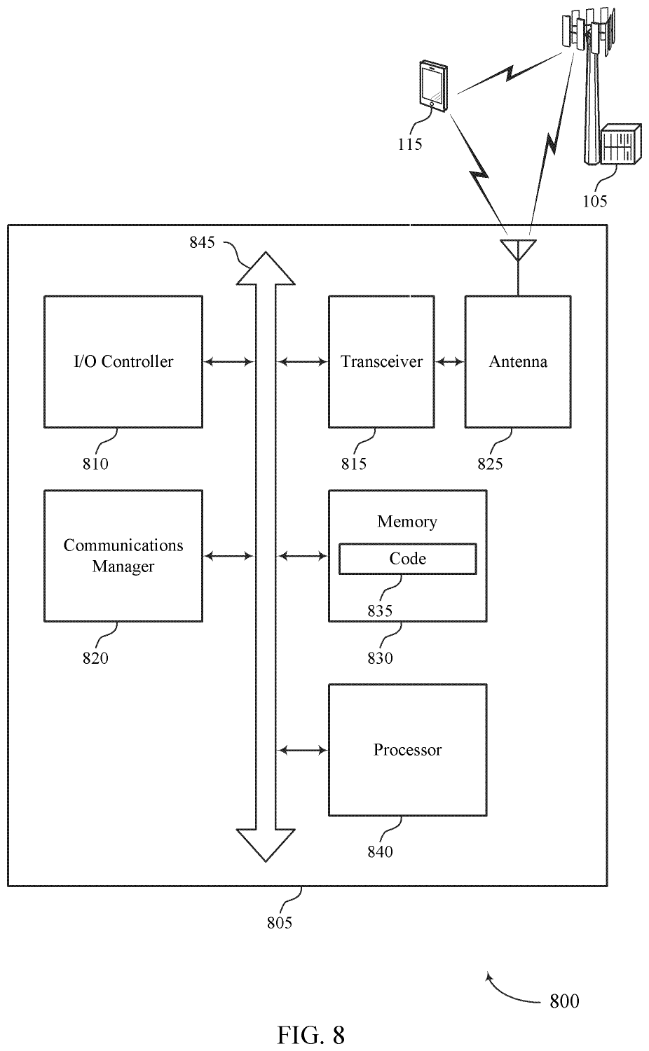

FIG. 8 shows a diagram of a system 800 including a device 805 that supports ML models for predictive resource management in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting ML models for predictive resource management). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving signaling identifying a configuration of a set of multiple ML models for channel characteristic prediction, where the channel characteristic prediction for each ML model of the set of multiple ML models is based on a respective reference signal resource of a set of multiple reference signal resources. The communications manager 820 may be configured as or otherwise support a means for obtaining an input to one or more ML models of the set of multiple ML models. The communications manager 820 may be configured as or otherwise support a means for processing the input using at least one ML model of the set of multiple ML models to obtain the channel characteristic prediction of the at least one ML model.

By including or configuring the communications manager 820 in accordance with examples as described herein, the device 805 may support techniques for a network entity to configure multiple ML models at a UE for channel characteristic prediction at the UE, which may provide for reduced latency, reduced overhead, reduced power consumption, more efficient utilization of communication resources, more robust operations, and improved accuracy of operations.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of ML models for predictive resource management as described herein, or the processor 840 and the memory 830 may be otherwise configured to perform or support such operations.

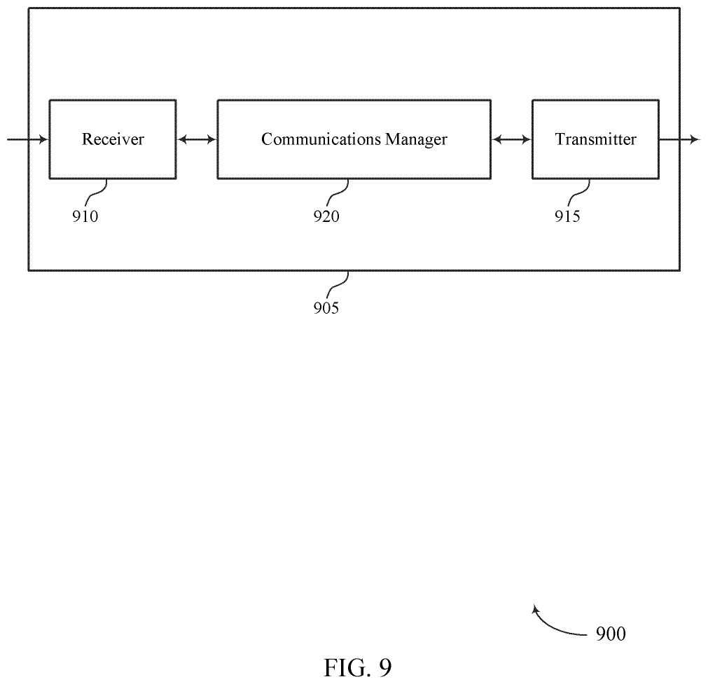

FIG. 9 shows a block diagram 900 of a device 905 that supports ML models for predictive resource management in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of ML models for predictive resource management as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting signaling identifying a configuration of a set of multiple ML models for channel characteristic prediction, where the channel characteristic prediction for each ML model of the set of multiple ML models is based on a reference signal resource of a set of multiple reference signal resources. The communications manager 920 may be configured as or otherwise support a means for obtaining an input to the set of multiple ML models based on performing one or more measurements associated with the set of multiple reference signal resources. The communications manager 920 may be configured as or otherwise support a means for outputting the input including the one or more measurements.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for a network entity to configure multiple ML models at a UE for channel characteristic prediction at the UE, which may provide for reduced power consumption and more efficient utilization of communication resources.

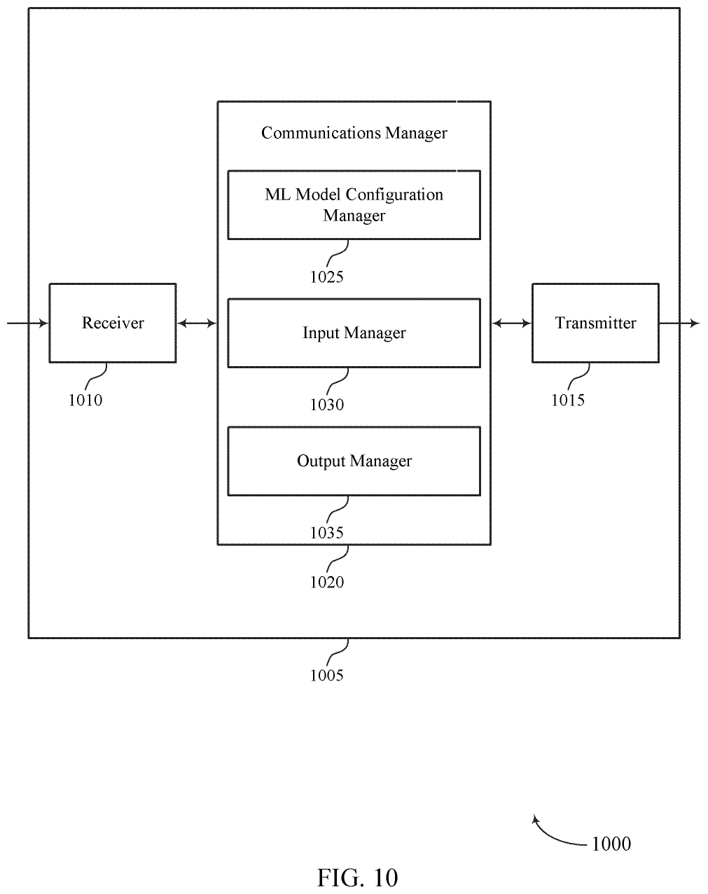

FIG. 10 shows a block diagram 1000 of a device 1005 that supports ML models for predictive resource management in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of ML models for predictive resource management as described herein. For example, the communications manager 1020 may include an ML model configuration manager 1025, an input manager 1030, an output manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The ML model configuration manager 1025 may be configured as or otherwise support a means for transmitting signaling identifying a configuration of a set of multiple ML models for channel characteristic prediction, where the channel characteristic prediction for each ML model of the set of multiple ML models is based on a reference signal resource of a set of multiple reference signal resources. The input manager 1030 may be configured as or otherwise support a means for obtaining an input to the set of multiple ML models based on performing one or more measurements associated with the set of multiple reference signal resources. The output manager 1035 may be configured as or otherwise support a means for outputting the input including the one or more measurements.

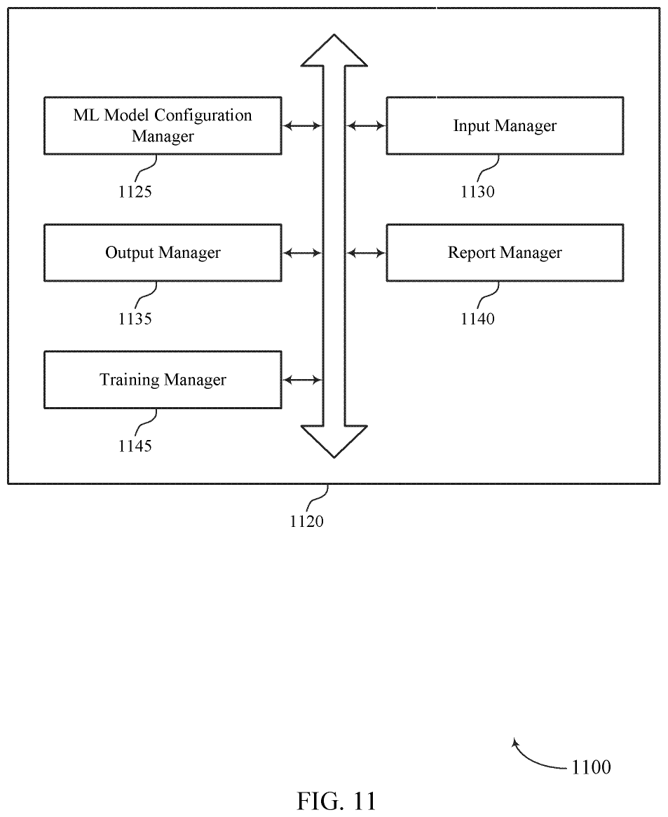

FIG. 11 shows a block diagram 1100 of a communications manager 1120 that supports ML models for predictive resource management in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of ML models for predictive resource management as described herein. For example, the communications manager 1120 may include an ML model configuration manager 1125, an input manager 1130, an output manager 1135, a report manager 1140, a training manager 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The ML model configuration manager 1125 may be configured as or otherwise support a means for transmitting signaling identifying a configuration of a set of multiple ML models for channel characteristic prediction, where the channel characteristic prediction for each ML model of the set of multiple ML models is based on a reference signal resource of a set of multiple reference signal resources. The input manager 1130 may be configured as or otherwise support a means for obtaining an input to the set of multiple ML models based on performing one or more measurements associated with the set of multiple reference signal resources. The output manager 1135 may be configured as or otherwise support a means for outputting the input including the one or more measurements.

In some examples, the ML model configuration manager 1125 may be configured as or otherwise support a means for outputting an indication of one or more ML models of the set of multiple ML models for processing the input.

In some examples, the ML model configuration manager 1125 may be configured as or otherwise support a means for outputting first signaling indicating one or more common layers corresponding to a common set of weights for the set of multiple ML models, one or more individual layers corresponding to an individual set of weights for the set of multiple ML models, or any combination thereof.

In some examples, the training manager 1145 may be configured as or otherwise support a means for outputting second signaling indicating for a UE to train the set of multiple ML models.

In some examples, the report manager 1140 may be configured as or otherwise support a means for obtaining a report including one or more target metrics associated with the channel characteristic prediction. In some examples, the output manager 1135 may be configured as or otherwise support a means for outputting the input based on the report.

In some examples, the input includes a time series of RSRP vectors associated with a respective reference signal resource of each ML model, a bitmap indicating an index of a strongest reference signal resource based on an RSRP vector of the time series of RSRP vectors, or any combination thereof.

In some examples, the channel characteristic prediction includes an indication of a likelihood that a first RSRP of a respective reference signal resource is different from a second RSRP associated with the input.

In some examples, the channel characteristic prediction includes an indication of one or more likelihoods that a reference signal resource measurement cycle will change for one or more respective threshold number of times.

In some examples, the channel characteristic prediction includes an RSRP prediction, an SINR prediction, an RI prediction, a PMI prediction, an LI prediction, a CQI prediction, or a combination thereof.

In some examples, the set of multiple reference signal resources include an SSB resource, a channel state information-reference signal resource, or any combination thereof.

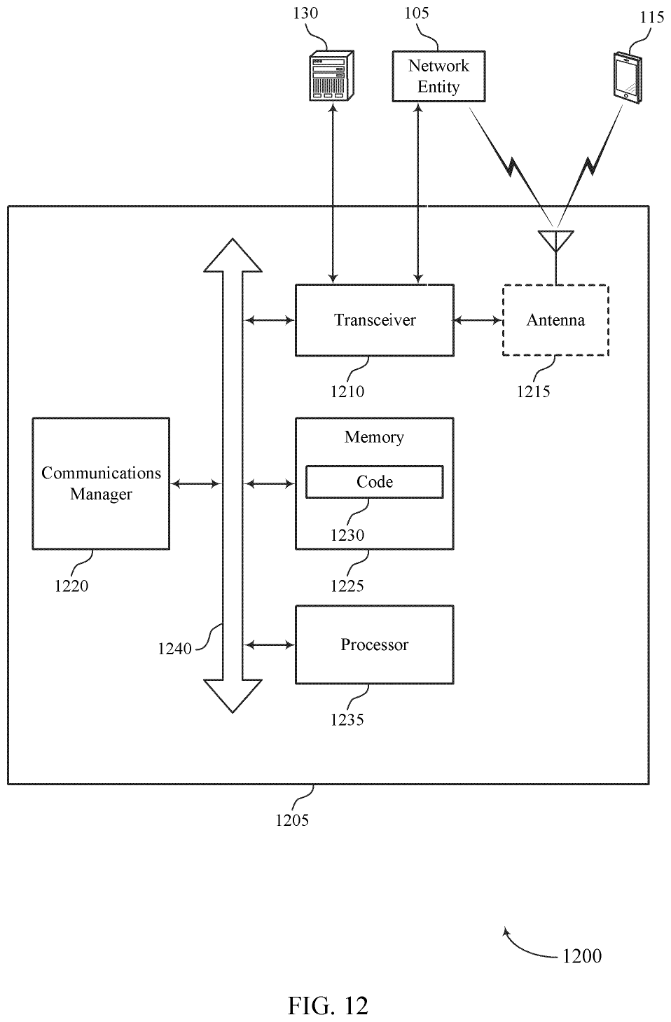

FIG. 12 shows a diagram of a system 1200 including a device 1205 that supports ML models for predictive resource management in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting ML models for predictive resource management). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting signaling identifying a configuration of a set of multiple ML models for channel characteristic prediction, where the channel characteristic prediction for each ML model of the set of multiple ML models is based on a reference signal resource of a set of multiple reference signal resources. The communications manager 1220 may be configured as or otherwise support a means for obtaining an input to the set of multiple ML models based on performing one or more measurements associated with the set of multiple reference signal resources. The communications manager 1220 may be configured as or otherwise support a means for outputting the input including the one or more measurements.

By including or configuring the communications manager 1220 in accordance with examples as described herein, the device 1205 may support techniques for a network entity to configure multiple ML models at a UE for channel characteristic prediction at the UE, which may provide for reduced latency, reduced overhead, reduced power consumption, more efficient utilization of communication resources, more robust operations, and improved accuracy of operations.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of ML models for predictive resource management as described herein, or the processor 1235 and the memory 1225 may be otherwise configured to perform or support such operations.

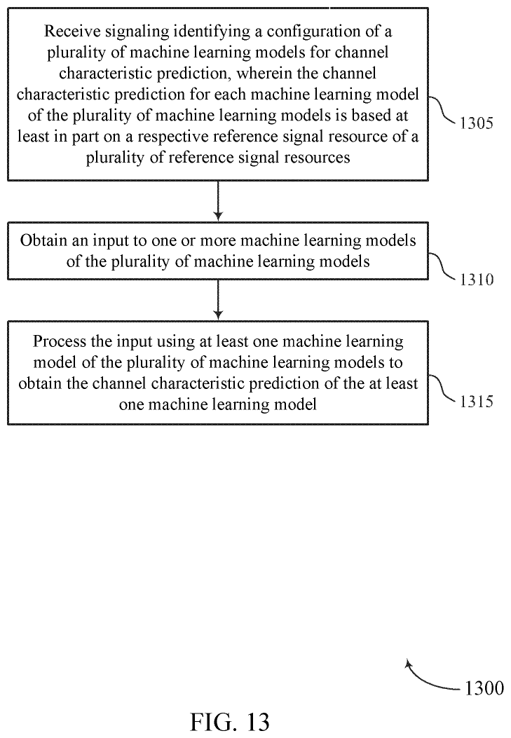

FIG. 13 shows a flowchart illustrating a method 1300 that supports ML models for predictive resource management in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving signaling identifying a configuration of a set of multiple ML models for channel characteristic prediction, where the channel characteristic prediction for each ML model of the set of multiple ML models is based on a respective reference signal resource of a set of multiple reference signal resources. The operations of 1305 may be performed in accordance with examples as disclosed herein. In some examples, aspects of the operations of 1305 may be performed by an ML model configuration component 725 as described with reference to FIG. 7.

At 1310, the method may include obtaining an input to one or more ML models of the set of multiple ML models. The operations of 1310 may be performed in accordance with examples as disclosed herein. In some examples, aspects of the operations of 1310 may be performed by an input component 730 as described with reference to FIG. 7.

At 1315, the method may include processing the input using at least one ML model of the set of multiple ML models to obtain the channel characteristic prediction of the at least one ML model. The operations of 1315 may be performed in accordance with examples as disclosed herein. In some examples, aspects of the operations of 1315 may be performed by an input processing component 735 as described with reference to FIG. 7.

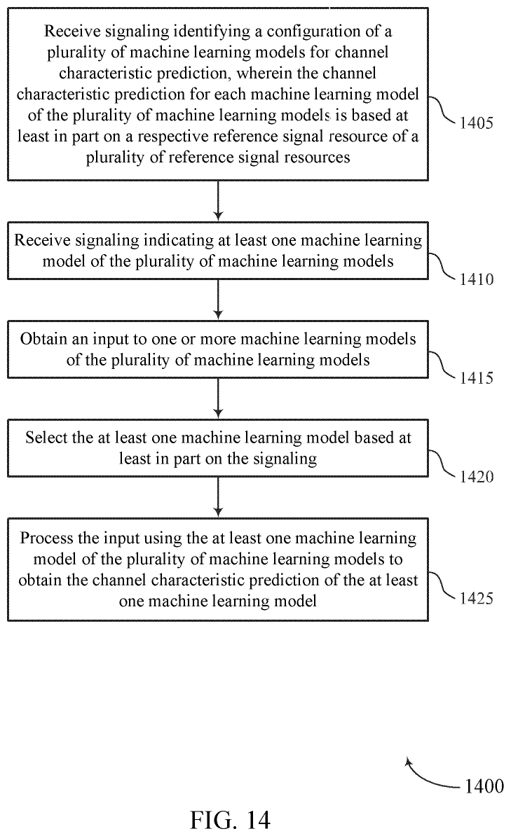

FIG. 14 shows a flowchart illustrating a method 1400 that supports ML models for predictive resource management in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving signaling identifying a configuration of a set of multiple ML models for channel characteristic prediction, where the channel characteristic prediction for each ML model of the set of multiple ML models is based on a respective reference signal resource of a set of multiple reference signal resources. The operations of 1405 may be performed in accordance with examples as disclosed herein. In some examples, aspects of the operations of 1405 may be performed by an ML model configuration component 725 as described with reference to FIG. 7.

At 1410, the method may include receiving signaling indicating at least one ML model of the set of multiple ML models. The operations of 1410 may be performed in accordance with examples as disclosed herein. In some examples, aspects of the operations of 1410 may be performed by an ML model selection component 740 as described with reference to FIG. 7.

At 1415, the method may include obtaining an input to one or more ML models of the set of multiple ML models. The operations of 1415 may be performed in accordance with examples as disclosed herein. In some examples, aspects of the operations of 1415 may be performed by an input component 730 as described with reference to FIG. 7.

At 1420, the method may include selecting the at least one ML model based on the signaling. The operations of 1420 may be performed in accordance with examples as disclosed herein. In some examples, aspects of the operations of 1420 may be performed by an ML model selection component 740 as described with reference to FIG. 7.

At 1425, the method may include processing the input using the at least one ML model of the set of multiple ML models to obtain the channel characteristic prediction of the at least one ML model. The operations of 1425 may be performed in accordance with examples as disclosed herein. In some examples, aspects of the operations of 1425 may be performed by an input processing component 735 as described with reference to FIG. 7.

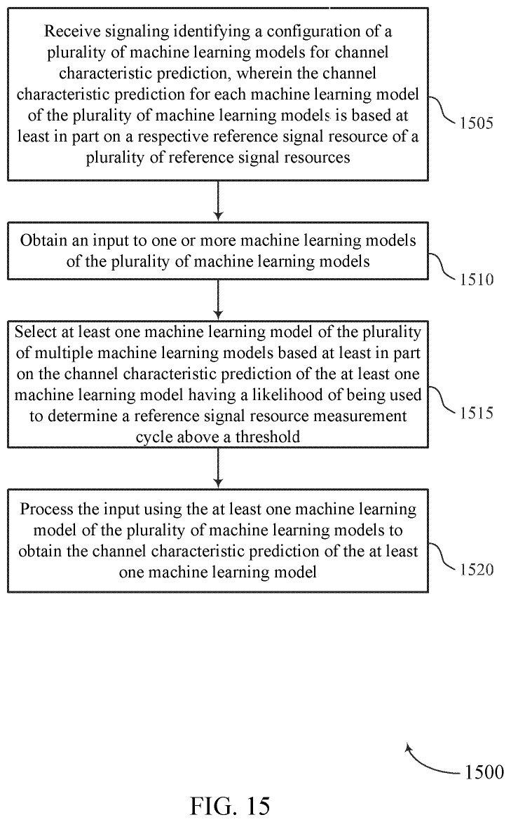

FIG. 15 shows a flowchart illustrating a method 1500 that supports ML models for predictive resource management in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving signaling identifying a configuration of a set of multiple ML models for channel characteristic prediction, where the channel characteristic prediction for each ML model of the set of multiple ML models is based on a respective reference signal resource of a set of multiple reference signal resources. The operations of 1505 may be performed in accordance with examples as disclosed herein. In some examples, aspects of the operations of 1505 may be performed by an ML model configuration component 725 as described with reference to FIG. 7.

At 1510, the method may include obtaining an input to one or more ML models of the set of multiple ML models. The operations of 1510 may be performed in accordance with examples as disclosed herein. In some examples, aspects of the operations of 1510 may be performed by an input component 730 as described with reference to FIG. 7.

At 1515, the method may include selecting at least one ML model of the set of multiple ML models based on the channel characteristic prediction of the at least one ML model having a likelihood of being used to determine a reference signal resource measurement cycle above a threshold. The operations of 1515 may be performed in accordance with examples as disclosed herein. In some examples, aspects of the operations of 1515 may be performed by an ML model selection component 740 as described with reference to FIG. 7.

At 1520, the method may include processing the input using the at least one ML model of the set of multiple ML models to obtain the channel characteristic prediction of the at least one ML model. The operations of 1520 may be performed in accordance with examples as disclosed herein. In some examples, aspects of the operations of 1520 may be performed by an input processing component 735 as described with reference to FIG. 7.

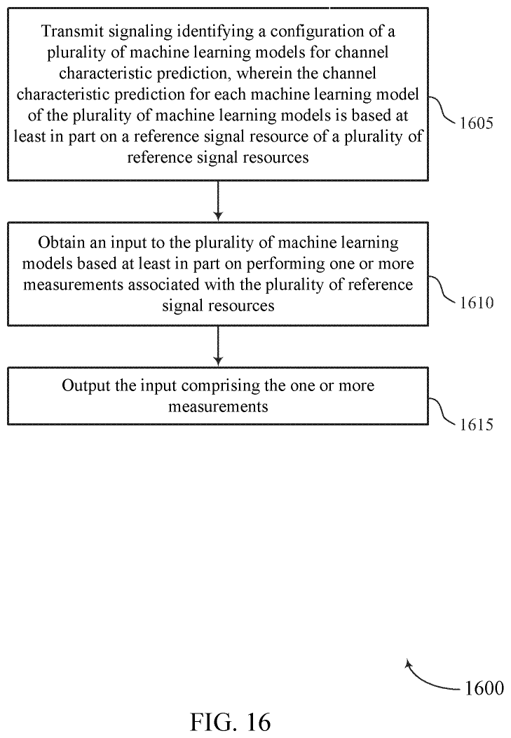

FIG. 16 shows a flowchart illustrating a method 1600 that supports ML models for predictive resource management in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting signaling identifying a configuration of a set of multiple ML models for channel characteristic prediction, where the channel characteristic prediction for each ML model of the set of multiple ML models is based on a reference signal resource of a set of multiple reference signal resources. The operations of 1605 may be performed in accordance with examples as disclosed herein. In some examples, aspects of the operations of 1605 may be performed by an ML model configuration manager 1125 as described with reference to FIG. 11.

At 1610, the method may include obtaining an input to the set of multiple ML models based on performing one or more measurements associated with the set of multiple reference signal resources. The operations of 1610 may be performed in accordance with examples as disclosed herein. In some examples, aspects of the operations of 1610 may be performed by an input manager 1130 as described with reference to FIG. 11.

At 1615, the method may include outputting the input including the one or more measurements. The operations of 1615 may be performed in accordance with examples as disclosed herein. In some examples, aspects of the operations of 1615 may be performed by an output manager 1135 as described with reference to FIG. 11.

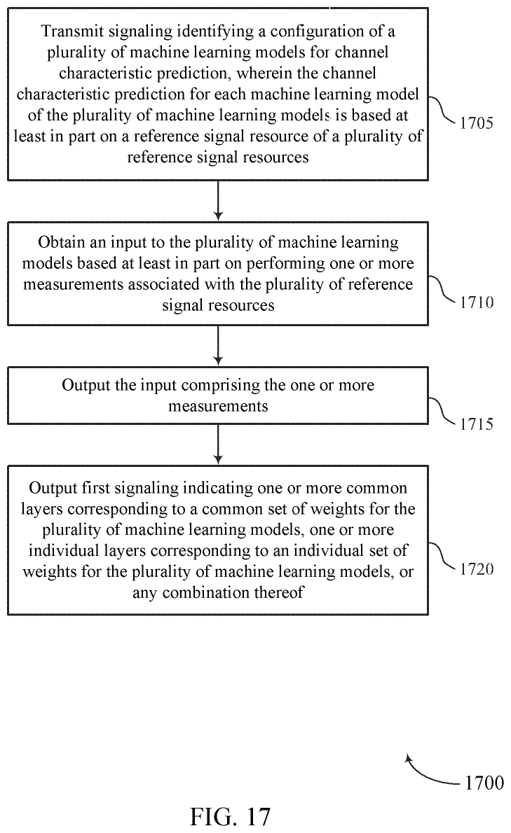

FIG. 17 shows a flowchart illustrating a method 1700 that supports ML models for predictive resource management in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting signaling identifying a configuration of a set of multiple ML models for channel characteristic prediction, where the channel characteristic prediction for each ML model of the set of multiple ML models is based on a reference signal resource of a set of multiple reference signal resources. The operations of 1705 may be performed in accordance with examples as disclosed herein. In some examples, aspects of the operations of 1705 may be performed by an ML model configuration manager 1125 as described with reference to FIG. 11.

At 1710, the method may include obtaining an input to the set of multiple ML models based on performing one or more measurements associated with the set of multiple reference signal resources. The operations of 1710 may be performed in accordance with examples as disclosed herein. In some examples, aspects of the operations of 1710 may be performed by an input manager 1130 as described with reference to FIG. 11.

At 1715, the method may include outputting the input including the one or more measurements. The operations of 1715 may be performed in accordance with examples as disclosed herein. In some examples, aspects of the operations of 1715 may be performed by an output manager 1135 as described with reference to FIG. 11.

At 1720, the method may include outputting first signaling indicating one or more common layers corresponding to a common set of weights for the set of multiple ML models, one or more individual layers corresponding to an individual set of weights for the set of multiple ML models, or any combination thereof. The operations of 1720 may be performed in accordance with examples as disclosed herein. In some examples, aspects of the operations of 1720 may be performed by an ML model configuration manager 1125 as described with reference to FIG. 11.

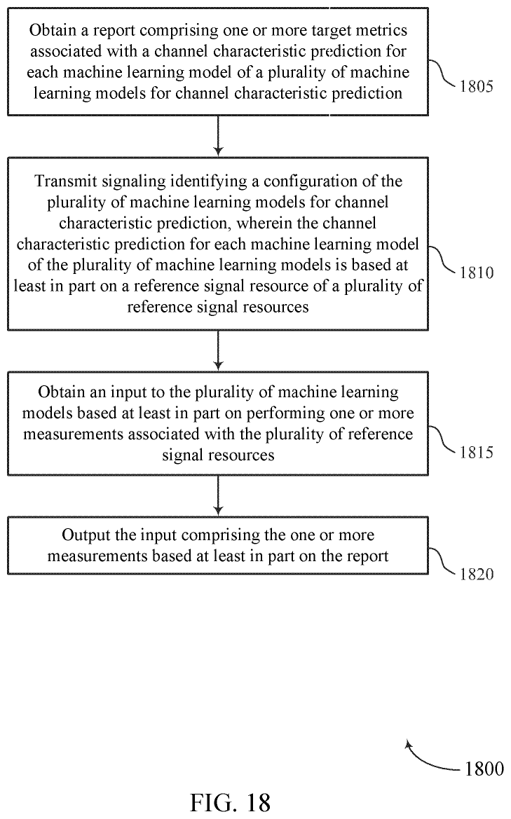

FIG. 18 shows a flowchart illustrating a method 1800 that supports ML models for predictive resource management in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include obtaining a report including one or more target metrics associated with a channel characteristic prediction for each ML model of a set of multiple ML models for channel characteristic prediction. The operations of 1805 may be performed in accordance with examples as disclosed herein. In some examples, aspects of the operations of 1805 may be performed by a report manager 1140 as described with reference to FIG. 11.

At 1810, the method may include transmitting signaling identifying a configuration of the set of multiple ML models for channel characteristic prediction, where the channel characteristic prediction for each ML model of the set of multiple ML models is based on a reference signal resource of a set of multiple reference signal resources. The operations of 1810 may be performed in accordance with examples as disclosed herein. In some examples, aspects of the operations of 1810 may be performed by an ML model configuration manager 1125 as described with reference to FIG. 11.

At 1815, the method may include obtaining an input to the set of multiple ML models based on performing one or more measurements associated with the set of multiple reference signal resources. The operations of 1815 may be performed in accordance with examples as disclosed herein. In some examples, aspects of the operations of 1815 may be performed by an input manager 1130 as described with reference to FIG. 11.

At 1820, the method may include outputting the input including the one or more measurements based at least in part on the report. The operations of 1820 may be performed in accordance with examples as disclosed herein. In some examples, aspects of the operations of 1820 may be performed by an output manager 1135 as described with reference to FIG. 11.

The following provides an overview of aspects of the present disclosure:

Aspect 1: A method for wireless communication at a UE, comprising: receiving signaling identifying a configuration of a plurality of machine learning models for channel characteristic prediction, wherein the channel characteristic prediction for each machine learning model of the plurality of machine learning models is based at least in part on a respective reference signal resource of a plurality of reference signal resources; obtaining an input to one or more machine learning models of the plurality of machine learning models; and processing the input using at least one machine learning model of the plurality of machine learning models to obtain the channel characteristic prediction of the at least one machine learning model.

Aspect 2: The method of aspect 1, further comprising: receiving signaling indicating the at least one machine learning model; and selecting the at least one machine learning model based at least in part on the signaling.

Aspect 3: The method of any of aspects 1 through 2, further comprising: selecting the at least one machine learning model based at least in part on the channel characteristic prediction of the at least one machine learning model having a likelihood of being used to determine a reference signal resource measurement cycle above a threshold.

Aspect 4: The method of aspect 3, further comprising: determining the likelihood of being used to determine the reference signal resource measurement cycle for each machine learning model of the plurality of machine learning models based at least in part on applying a separate machine learning model.

Aspect 5: The method of any of aspects 3 through 4, wherein the threshold is a probability value or a binary output.

Aspect 6: The method of any of aspects 1 through 5, further comprising: selecting the at least one machine learning model based at least in part on the channel characteristic prediction of the at least one machine learning model having a greatest reference signal receive power vector of the one or more machine learning models.

Aspect 7: The method of aspect 6, further comprising: receiving an indication of the one or more machine learning models from a network entity.

Aspect 8: The method of any of aspects 1 through 7, further comprising: receiving first signaling indicating one or more common layers corresponding to a common set of weights for the plurality of machine learning models, one or more individual layers corresponding to an individual set of weights for the plurality of machine learning models, or any combination thereof.

Aspect 9: The method of aspect 8, further comprising: updating the one or more individual layers corresponding to the individual set of weights for the plurality of machine learning models based at least in part on training the plurality of machine learning models according to federated learning.

Aspect 10: The method of aspect 9, further comprising: receiving second signaling indicating for the UE to train the plurality of machine learning models, wherein the updating is based at least in part on the second signaling.

Aspect 11: The method of any of aspects 1 through 10, further comprising: transmitting a report comprising one or more target metrics associated with the channel characteristic prediction; and receiving the input to the one or more machine learning models based at least in part on the report.

Aspect 12: The method of any of aspects 1 through 11, wherein the input for each machine learning model of the one or more machine learning models comprises a time series of reference signal receive power vectors associated with the respective reference signal resource of the each machine learning model, a bitmap indicating one or more indices of one or more respective strongest reference signal resources based at least in part on a reference signal receive power vector of the time series of reference signal receive power vectors, or any combination thereof.

Aspect 13: The method of any of aspects 1 through 12, wherein the channel characteristic prediction comprises a probability or a binary output indicating that a first index of the respective reference signal resource with a strongest reference signal receive power is different from a second index of an additional reference signal resource associated with a strongest reference signal receive power for the input for a duration comprising a time between when the respective reference signal resource and the additional reference signal resource are measured.

Aspect 14: The method of any of aspects 1 through 13, wherein the channel characteristic prediction comprises an indication of one or more likelihoods that a reference signal resource measurement cycle will change for one or more respective threshold number of times.

Aspect 15: The method of any of aspects 1 through 14, wherein the at least one machine learning model predicts one or more future channel characteristics based at least in part on one or more current channel characteristic measurements, one or more previous channel characteristic measurements, or any combination thereof associated with the respective reference signal resource.

Aspect 16: The method of any of aspects 1 through 15, wherein the at least one machine learning model predicts one or more channel characteristics of the respective reference signal resource, an angle of departure for downlink precoding associated with the respective reference signal resource, a linear combination of one or more measurements associated with the respective reference signal resource, or any combination thereof.

Aspect 17: The method of any of aspects 1 through 16, wherein the at least one machine learning model predicts one or more channel characteristics for a first frequency range based at least in part on measuring one or more channel characteristics for a second frequency range.

Aspect 18: The method of any of aspects 1 through 17, wherein the channel characteristic prediction comprises a reference signal receive power prediction, a signal-to-interference-plus-noise ratio prediction, a rank indicator prediction, a precoding matrix indicator prediction, a layer indicator prediction, a channel quality indicator prediction, or a combination thereof.

Aspect 19: The method of any of aspects 1 through 18, wherein the plurality of reference signal resources comprise a synchronization signal block resource, a channel state information-reference signal resource, or any combination thereof.

Aspect 20: A method for wireless communication at a network entity, comprising: transmitting signaling identifying a configuration of a plurality of machine learning models for channel characteristic prediction, wherein the channel characteristic prediction for each machine learning model of the plurality of machine learning models is based at least in part on a reference signal resource of a plurality of reference signal resources; obtaining an input to the plurality of machine learning models based at least in part on performing one or more measurements associated with the plurality of reference signal resources; and outputting the input comprising the one or more measurements.

Aspect 21: The method of aspect 20, further comprising: outputting an indication of one or more machine learning models of the plurality of machine learning models for processing the input.

Aspect 22: The method of any of aspects 20 through 21, further comprising:

outputting first signaling indicating one or more common layers corresponding to a common set of weights for the plurality of machine learning models, one or more individual layers corresponding to an individual set of weights for the plurality of machine learning models, or any combination thereof.

Aspect 23: The method of aspect 22, further comprising: outputting second signaling indicating for a UE to train the plurality of machine learning models.

Aspect 24: The method of any of aspects 20 through 23, further comprising: obtaining a report comprising one or more target metrics associated with the channel characteristic prediction; and outputting the input based at least in part on the report.

Aspect 25: The method of any of aspects 20 through 24, wherein the input comprises a time series of reference signal receive power vectors associated with a respective reference signal resource of each machine learning model, a bitmap indicating an index of a strongest reference signal resource based at least in part on a reference signal receive power vector of the time series of reference signal receive power vectors, or any combination thereof.

Aspect 26: The method of any of aspects 20 through 25, wherein the channel characteristic prediction comprises an indication of a likelihood that a first reference signal receive power of a respective reference signal resource is different from a second reference signal receive power associated with the input.

Aspect 27: The method of any of aspects 20 through 26, wherein the channel characteristic prediction comprises an indication of one or more likelihoods that a reference signal resource measurement cycle will change for one or more respective threshold number of times.

Aspect 28: The method of any of aspects 20 through 27, wherein the channel characteristic prediction comprises a reference signal receive power prediction, a signal-to-interference-plus-noise ratio prediction, a rank indicator prediction, a precoding matrix indicator prediction, a layer indicator prediction, a channel quality indicator prediction, or a combination thereof.

Aspect 29: The method of any of aspects 20 through 28, wherein the plurality of reference signal resources comprise a synchronization signal block resource, a channel state information-reference signal resource, or any combination thereof.

Aspect 30: An apparatus for wireless communication at a UE, comprising a processor; memory coupled with the processor; and instructions stored in the memory and executable by the processor to cause the apparatus to perform a method of any of aspects 1 through 19.

Aspect 31: An apparatus for wireless communication at a UE, comprising at least one means for performing a method of any of aspects 1 through 19.

Aspect 32: A non-transitory computer-readable medium storing code for wireless communication at a UE, the code comprising instructions executable by a processor to perform a method of any of aspects 1 through 19.

Aspect 33: An apparatus for wireless communication at a network entity, comprising a processor; memory coupled with the processor; and instructions stored in the memory and executable by the processor to cause the apparatus to perform a method of any of aspects 20 through 29.

Aspect 34: An apparatus for wireless communication at a network entity, comprising at least one means for performing a method of any of aspects 20 through 29.

Aspect 35: A non-transitory computer-readable medium storing code for wireless communication at a network entity, the code comprising instructions executable by a processor to perform a method of any of aspects 20 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving signaling identifying a configuration of a plurality of machine learning models for channel characteristic prediction, wherein the channel characteristic prediction for each machine learning model of the plurality of machine learning models is based at least in part on a respective reference signal resource of a plurality of reference signal resources;
obtaining an input to one or more machine learning models of the plurality of machine learning models; and
processing the input using at least one machine learning model of the plurality of machine learning models to obtain the channel characteristic prediction of the at least one machine learning model.

2. The method of claim 1, further comprising:
receiving signaling indicating the at least one machine learning model; and
selecting the at least one machine learning model based at least in part on the signaling.

3. The method of claim 1, further comprising:
selecting the at least one machine learning model based at least in part on the channel characteristic prediction of the at least one machine learning model having a likelihood of being used to determine a reference signal resource measurement cycle above a threshold.

4. The method of claim 3, further comprising:
determining the likelihood of being used to determine the reference signal resource measurement cycle for each machine learning model of the plurality of machine learning models based at least in part on applying a separate machine learning model.

5. The method of claim 3, wherein the threshold is a probability value or a binary output.

6. The method of claim 1, further comprising:
selecting the at least one machine learning model based at least in part on the channel characteristic prediction of the at least one machine learning model having a greatest reference signal receive power vector of the one or more machine learning models.

7. The method of claim 6, further comprising:
receiving an indication of the one or more machine learning models from a network entity.

8. The method of claim 1, further comprising:
receiving first signaling indicating one or more common layers corresponding to a common set of weights for the plurality of machine learning models, one or more individual layers corresponding to an individual set of weights for the plurality of machine learning models, or any combination thereof.

9. The method of claim 8, further comprising:
updating the one or more individual layers corresponding to the individual set of weights for the plurality of machine learning models based at least in part on training the plurality of machine learning models according to federated learning.

10. The method of claim 9, further comprising:
receiving second signaling indicating for the UE to train the plurality of machine learning models, wherein the updating is based at least in part on the second signaling.

11. The method of claim 1, further comprising:
transmitting a report comprising one or more target metrics associated with the channel characteristic prediction; and
receiving the input to the one or more machine learning models based at least in part on the report.

12. The method of claim 1, wherein the input for each machine learning model of the one or more machine learning models comprises a time series of reference signal receive power vectors associated with the respective reference signal resource of each machine learning model, a bitmap indicating one or more indices of one or more respective strongest reference signal resources based at least in part on a reference signal receive power vector of the time series of reference signal receive power vectors, or any combination thereof.

13. The method of claim 1, wherein the channel characteristic prediction comprises a probability or a binary output indicating that a first index of the respective reference signal resource with a strongest reference signal receive power is different from a second index of an additional reference signal resource associated with a strongest reference signal receive power for the input for a duration comprising a time between when the respective reference signal resource and the additional reference signal resource are measured.

14. The method of claim 1, wherein the channel characteristic prediction comprises an indication of one or more likelihoods that a reference signal resource measurement cycle will change for one or more respective threshold number of times.

15. The method of claim 1, wherein the at least one machine learning model predicts one or more future channel characteristics based at least in part on one or more current channel characteristic measurements, one or more previous channel characteristic measurements, or any combination thereof associated with the respective reference signal resource.

16. The method of claim 1, wherein the at least one machine learning model predicts one or more channel characteristics of the respective reference signal resource, an angle of departure for downlink precoding associated with the respective reference signal resource, a linear combination of one or more measurements associated with the respective reference signal resource, or any combination thereof.

17. The method of claim 1, wherein the at least one machine learning model predicts one or more channel characteristics for a first frequency range based at least in part on measuring one or more channel characteristics for a second frequency range.

18. The method of claim 1, wherein the channel characteristic prediction comprises a reference signal receive power prediction, a signal-to-interference-plus-noise ratio prediction, a rank indicator prediction, a precoding matrix indicator prediction, a layer indicator prediction, a channel quality indicator prediction, or a combination thereof.

19. The method of claim 1, wherein the plurality of reference signal resources comprise a synchronization signal block resource, a channel state information-reference signal resource, or any combination thereof.

20. A method for wireless communication at a network entity, comprising:
transmitting signaling identifying a configuration of a plurality of machine learning models for channel characteristic prediction, wherein the channel characteristic prediction for each machine learning model of the plurality of machine learning models is based at least in part on a reference signal resource of a plurality of reference signal resources;
obtaining an input to the plurality of machine learning models based at least in part on performing one or more measurements associated with the plurality of reference signal resources; and
outputting the input comprising the one or more measurements.

21. The method of claim 20, further comprising:
outputting an indication of one or more machine learning models of the plurality of machine learning models for processing the input.

22. The method of claim 20, further comprising:
outputting first signaling indicating one or more common layers corresponding to a common set of weights for the plurality of machine learning models, one or more individual layers corresponding to an individual set of weights for the plurality of machine learning models, or any combination thereof.

23. The method of claim 22, further comprising:
outputting second signaling indicating for a user equipment (UE) to train the plurality of machine learning models.

24. The method of claim 20, further comprising:
obtaining a report comprising one or more target metrics associated with the channel characteristic prediction; and
outputting the input based at least in part on the report.

25. The method of claim 20, wherein the input comprises a time series of reference signal receive power vectors associated with a respective reference signal resource of each machine learning model, a bitmap indicating an index of a strongest reference signal resource based at least in part on a reference signal receive power vector of the time series of reference signal receive power vectors, or any combination thereof.

26. The method of claim 20, wherein the channel characteristic prediction comprises an indication of a likelihood that a first reference signal receive power of a respective reference signal resource is different from a second reference signal receive power associated with the input.

27. The method of claim 20, wherein the channel characteristic prediction comprises an indication of one or more likelihoods that a reference signal resource measurement cycle will change for one or more respective threshold number of times.

28. The method of claim 20, wherein the plurality of reference signal resources comprise a synchronization signal block resource, a channel state information-reference signal resource, or any combination thereof.

29. An apparatus for wireless communication at a user equipment (UE), comprising:
a processor;
memory coupled with the processor; and
instructions stored in the memory and executable by the processor to cause the apparatus to:
receive signaling identifying a configuration of a plurality of machine learning models for channel characteristic prediction, wherein the channel characteristic prediction for each machine learning model of the plurality of machine learning models is based at least in part on a respective reference signal resource of a plurality of reference signal resources;
obtain an input to one or more machine learning models of the plurality of machine learning models; and
process the input using at least one machine learning model of the plurality of machine learning models to obtain the channel characteristic prediction of the at least one machine learning model.

30. An apparatus for wireless communication at a network entity, comprising:
a processor;
memory coupled with the processor; and
instructions stored in the memory and executable by the processor to cause the apparatus to:
transmit signaling identifying a configuration of a plurality of machine learning models for channel characteristic prediction, wherein the channel characteristic prediction for each machine learning model of the plurality of machine learning models is based at least in part on a reference signal resource of a plurality of reference signal resources;
obtain an input to the plurality of machine learning models based at least in part on performing one or more measurements associated with the plurality of reference signal resources; and
output the input comprising the one or more measurements.
